(19) United States
(12) Patent Application Publication
(10) Pub. No.: US 2026/0061743 A1
(43) Pub. Date: Mar. 5, 2026

(54) CONTROLLER, CONTROLLING METHOD, AND NON-TRANSITORY COMPUTER-READABLE STORAGE MEDIUM THEREFOR

(71) Applicant: BROTHER KOGYO KABUSHIKI KAISHA, Nagoya (JP)

(72) Inventor: Syuya YAMADA, Nagoya (JP)

(21) Appl. No.: 19/314,186

(22) Filed: Aug. 29, 2025

(30) Foreign Application Priority Data
Aug. 30, 2024 (JP) 2024-150143

(51) Int. Cl. B41J 2/045; B41J 2/21

(52) U.S. Cl. CPC B41J 2/04586; B41J 2/2103

(57) ABSTRACT

A controller controls a print engine including a print head with L nozzle groups to eject L types of ink (L≥2), a conveying mechanism to convey a sheet in a conveying direction, and a moving mechanism to move the print head in a moving direction intersecting the conveying direction. The L nozzle groups are arranged in the moving direction and include multiple nozzles having different positions in the conveying direction. The controller causes the print engine to print multiple band images forming a target image at a resolution that is N times (N≥2) the nozzle resolution in the conveying direction. The controller performs a first mode to print a first band image using multiple pass processes including a first-direction pass process and a second-direction pass process, each forming dots of a partial line group, with the second-direction pass process performed after the first-direction pass process without moving the sheet.

### REFERENCE TO RELATED APPLICATIONS

This application claims priority from Japanese Patent Application No. 2024-150143 filed on August 30, 2024. The entire content of the priority application is incorporated herein by reference.

### BACKGROUND ART

The present disclosure relates to a technique of controlling a print engine of an image forming device which is configured to print an image by ejecting ink.

A printing method that performs partial overlay printing has been known. In this method, partial overlay printing is applied to a lower edge of an upper pattern and an upper edge of a lower pattern. In other words, the upper and lower patterns are printed such that their adjacent edges partially overlap.

### SUMMARY

A print engine configured to move a print head in a direction intersecting with a conveying direction of a printing sheet may be used. Such a print engine prints each of multiple band images aligned in the conveying direction by forming multiple dots on the sheet during the movement of the print head. In such printing, multiple band images that are intended to represent the same color may be perceived to have different colors.

According to aspects of the present disclosure, a controller for controlling a print engine of a printer is provided. The print engine includes a print head that has L nozzle groups configured to eject L types of ink, where L is an integer equal to or greater than two. A conveying mechanism is configured to convey a sheet in a conveying direction relative to the print head, and a moving mechanism is configured to move the print head in a moving direction that intersects with the conveying direction. The L nozzle groups are arranged in the moving direction, and each group includes multiple nozzles that are positioned at different positions in the conveying direction, allowing them to eject ink to form dots on the sheet.

The controller is configured to perform a band processing that causes the print engine to print multiple band images forming a target image. These band images are arranged on the sheet in the conveying direction and are printed through multiple pass processes. Each pass process includes forming multiple dots on raster lines extending in the moving direction while the print head is being moved. Each band image includes multiple raster lines arranged in the conveying direction at a resolution that is N times the resolution of the multiple nozzles in the conveying direction, where N is an integer equal to or greater than two.

The band processing includes operating in a first mode to print a first specific band image included in the multiple band images. In this first mode, the print engine performs multiple pass processes in which the print head alternately moves in a first direction parallel to the moving direction and in a second direction opposite to the first direction. The multiple pass processes in the first mode include a preceding pass process that forms part of multiple dots of a partial line group representing a part of the first specific band image, and a succeeding pass process that is performed without moving the sheet in the conveying direction to form the remaining dots of the partial line group. In the succeeding pass process, the print head is moved in a direction opposite to the direction used in the preceding pass process.

According to aspects of the present disclosure, a method of controlling a print engine of a printer is provided. The print engine includes a print head with L nozzle groups configured to eject L types of ink, where L is an integer equal to or greater than two, a conveying mechanism configured to convey a sheet in a conveying direction relative to the print head, and a moving mechanism configured to move the print head in a moving direction relative to the sheet. The L nozzle groups are arranged in the moving direction, and each group includes multiple nozzles whose positions in the conveying direction are different from each other, enabling them to eject ink to form dots on the sheet.

The method includes performing a band processing that causes the print engine to print multiple band images forming a target image. These band images are arranged on the sheet in the conveying direction and are printed through multiple pass processes. Each pass process includes forming multiple dots on raster lines extending in the moving direction by driving the print head while it is being moved. The multiple band images include multiple raster lines arranged in the conveying direction at a resolution that is N times the resolution of the multiple nozzles in the conveying direction, where N is an integer equal to or greater than two.

The band processing includes printing a first specific band image included in the multiple band images by using a first mode. In the first mode, the print engine performs multiple pass processes representing alternate execution of a first direction pass process for moving the print head in a first direction parallel to the moving direction and a second direction pass process for moving the print head in a second direction opposite to the first direction. The multiple pass processes in the first mode include a preceding pass process that forms part of multiple dots of a partial line group representing part of the first specific band image, and a succeeding pass process that is performed, without moving the sheet in the conveying direction, to form the remaining dots of the partial line group, with the print head being moved in the direction opposite to the preceding pass process.

According to aspects of the present disclosure, a non-transitory computer-readable storage medium is provided for a print engine of a printer. The print engine has a print head with L nozzle groups configured to eject L types of ink, where L is an integer equal to or greater than two, a conveying mechanism configured to convey a sheet in a conveying direction relative to the print head, and a moving mechanism configured to move the print head in a moving direction relative to the sheet. The L nozzle groups are arranged in the moving direction, and each group includes multiple nozzles whose positions in the conveying direction are different from each other, enabling them to eject ink to form dots on the sheet.

The storage medium contains computer-executable instructions that, when executed by a computer, cause the print engine to perform processing. This includes printing multiple band images forming a target image on the sheet, where the band images are arranged in the conveying direction and printed through multiple pass processes. Each pass process includes forming multiple dots on raster lines extending in the moving direction by driving the print head during its movement. The multiple band images include multiple raster lines arranged in the conveying direction at a resolution that is N times the resolution of the multiple nozzles in the conveying direction, where N is an integer equal to or greater than two.

The instructions further cause the print engine to print a first specific band image included in the multiple band images using a first mode. In the first mode, the print engine performs multiple pass processes representing alternate execution of a first direction pass process for moving the print head in a first direction parallel to the moving direction and a second direction pass process for moving the print head in a second direction opposite to the first direction. The multiple pass processes in the first mode include a preceding pass process that forms part of multiple dots of a partial line group representing part of the first specific band image, and a succeeding pass process that is performed, without moving the sheet in the conveying direction, to form the remaining dots of the partial line group, with the print head being moved in the direction opposite to the preceding pass process.

According to the above configurations, dots are formed on the partial line group, which represents part of the first specific band image, by both a preceding pass process and a succeeding pass process performed in a direction opposite to the preceding pass process. As a result, the likelihood that the perceived color of the printed partial line group is biased toward the perceived color produced solely by the first direction pass process is reduced. Similarly, the likelihood that the perceived color of the printed partial line group is biased toward the perceived color produced solely by the second direction pass process is also reduced. Accordingly, the first specific band image including the partial line group can reduce the possibility that the perceived color differs from that of other band images supposed to exhibit the same color.

It is noted that the technology disclosed herein can be implemented in various forms, including, for example, as a method and a controller for controlling a print engine, a printing apparatus including the print engine and the controller, a computer program for implementing the functions of such methods or devices, and a storage medium (e.g., a non-transitory storage medium) storing such a computer program.

### BRIEF DESCRIPTION OF DRAWGINS

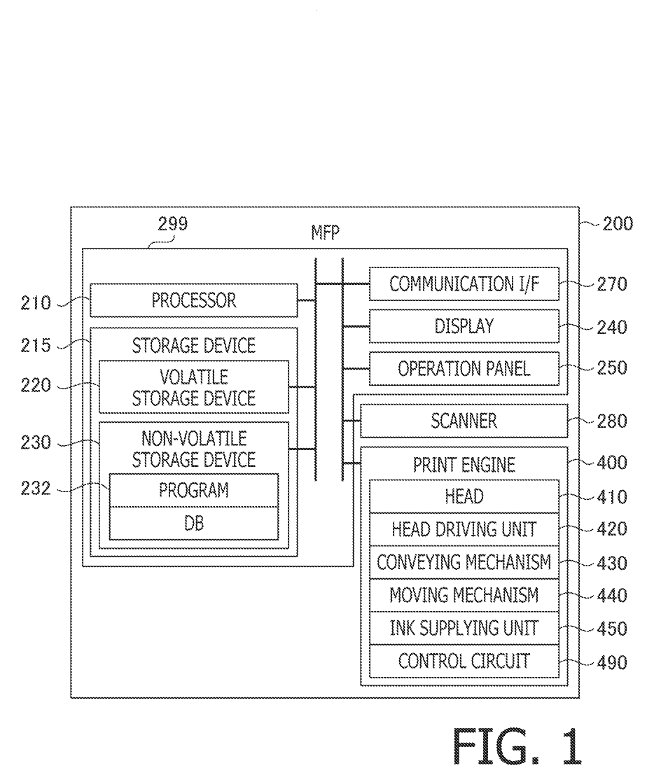

FIG. 1 is a block diagram illustrating a functional configuration of an MFP.

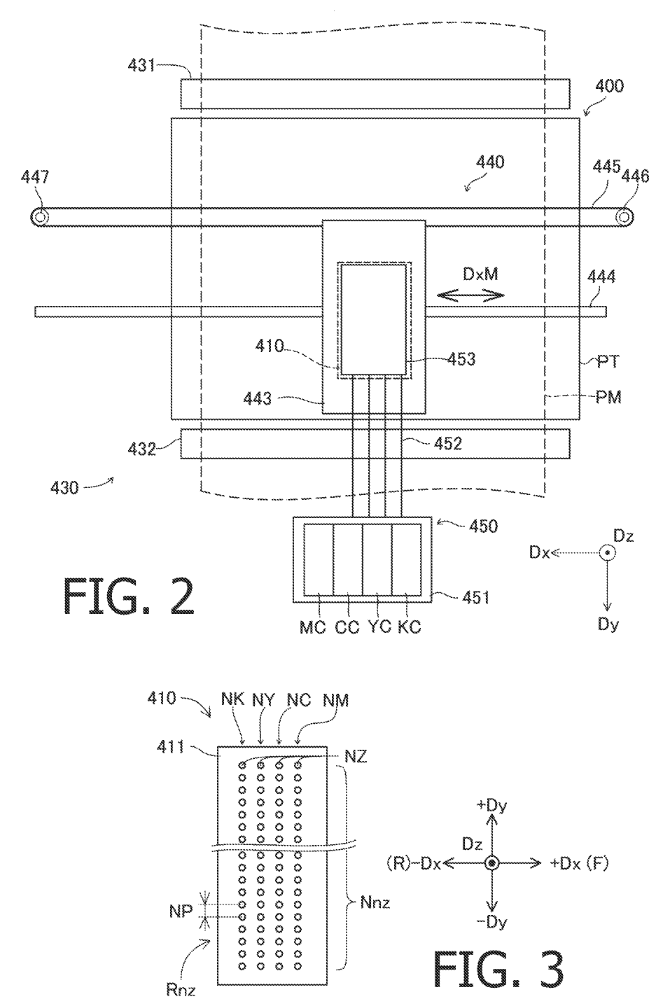

FIG. 2 schematically shows a plan view of a print engine of the MFP.

FIG. 3 is a view illustrating a bottom surface of a print head of the print engine.

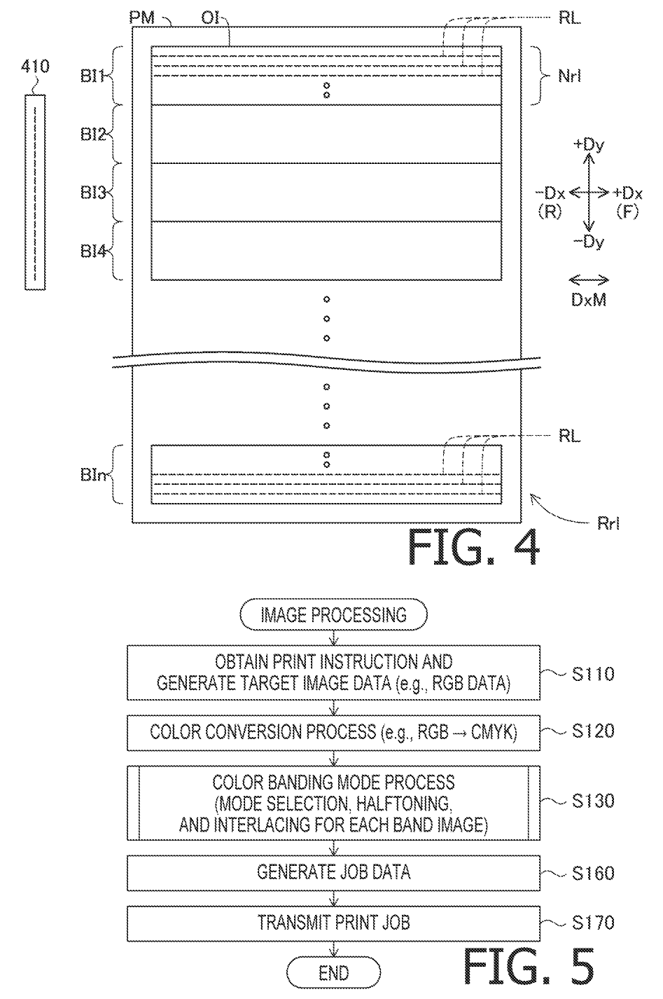

FIG. 4 schematically illustrates how printing is performed.

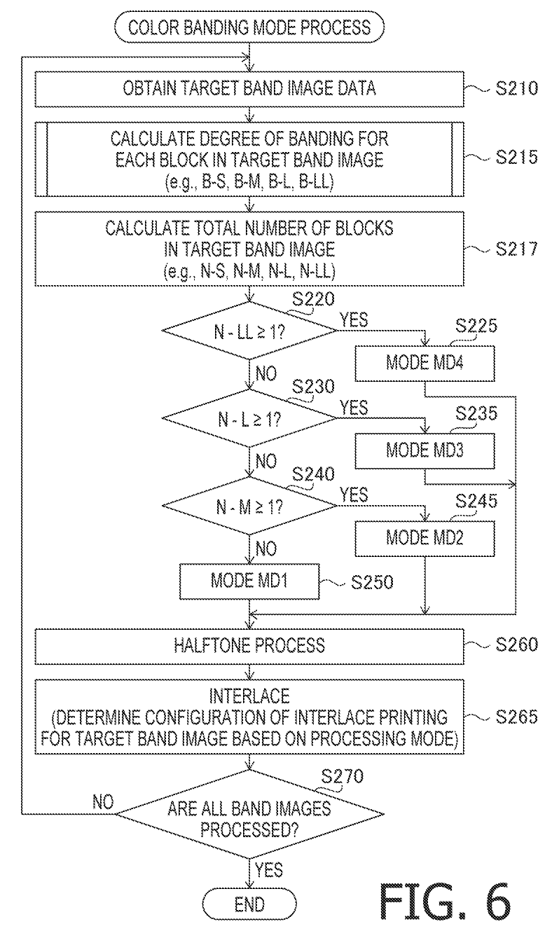

FIG. 5 is a flowchart illustrating an example of image processing for printing.

FIG. 6 is a flowchart illustrating an example a color banding mode process.

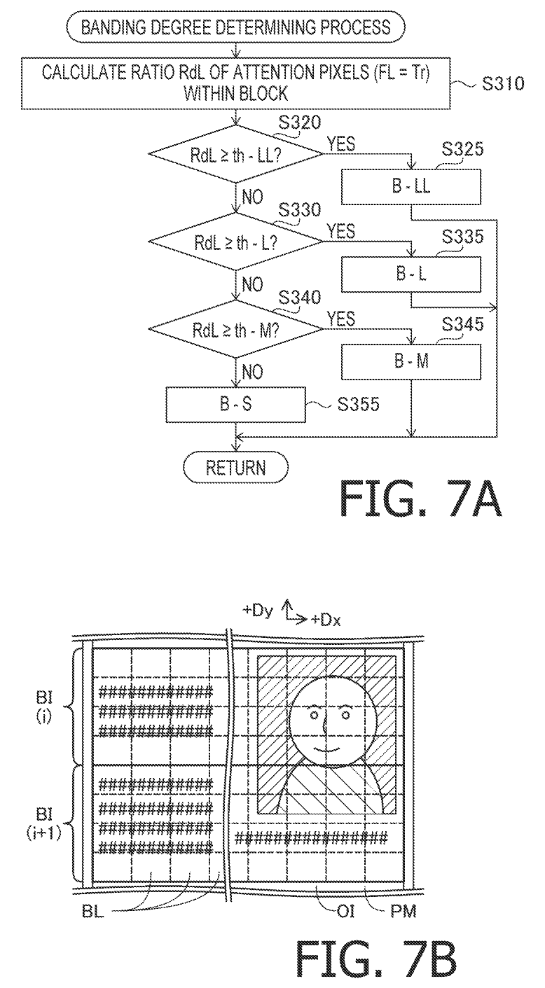

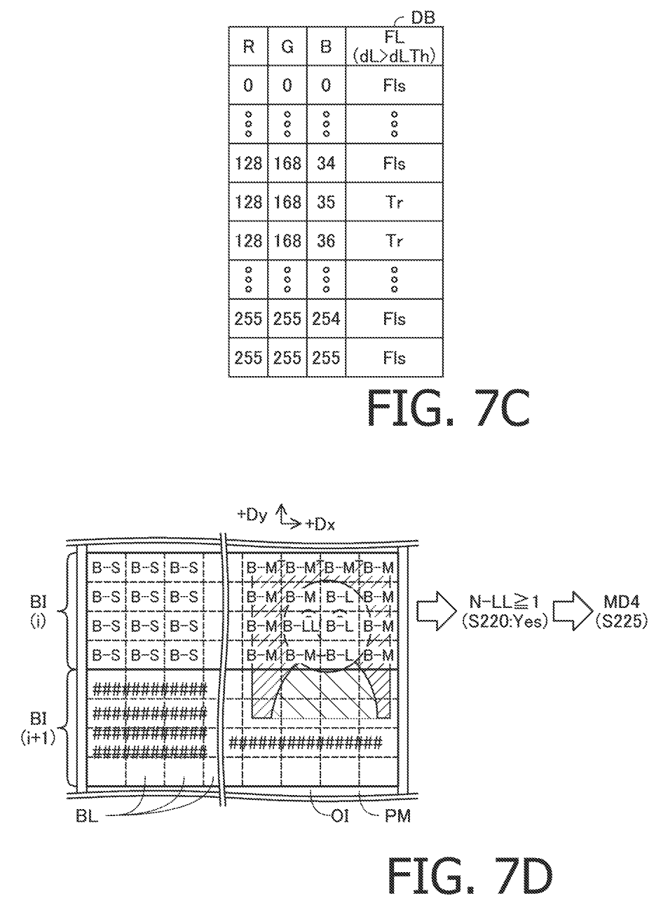

FIG. 7A illustrates a process of determining a degree of banding of in a single block.

FIG. 7B illustrates a relationship between an i-th band image and an (i+1)-th band image.

FIG. 7C is a diagram illustrating an example of color evaluation information database.

FIG. 7D illustrates an example of mode selection.

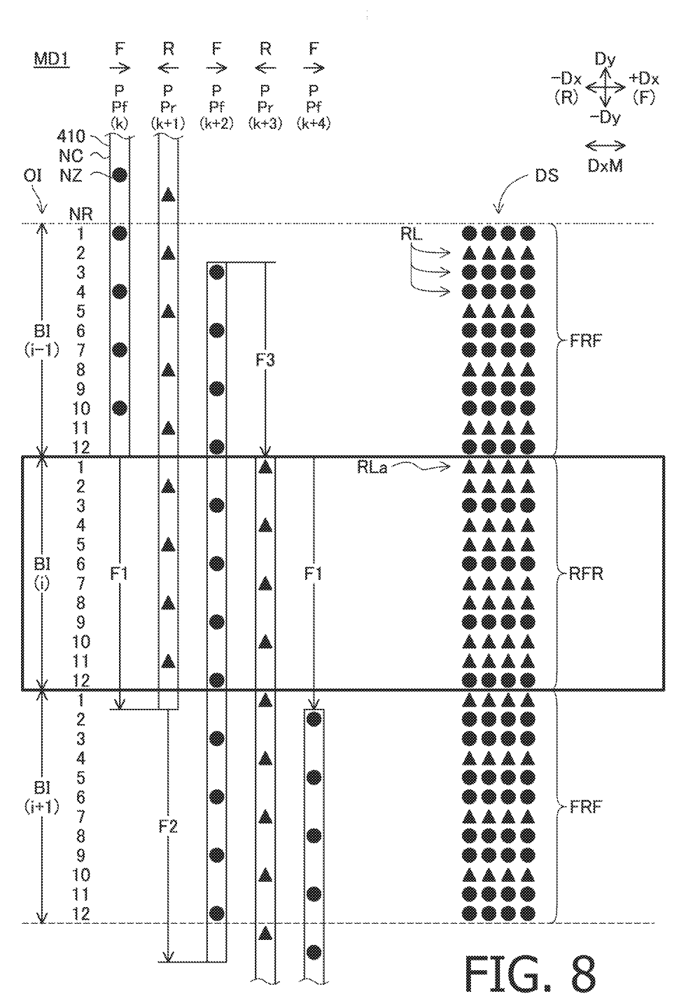

FIG. 8 is a diagram illustrating a relationship between a pass process and nozzle positions in a conveying direction.

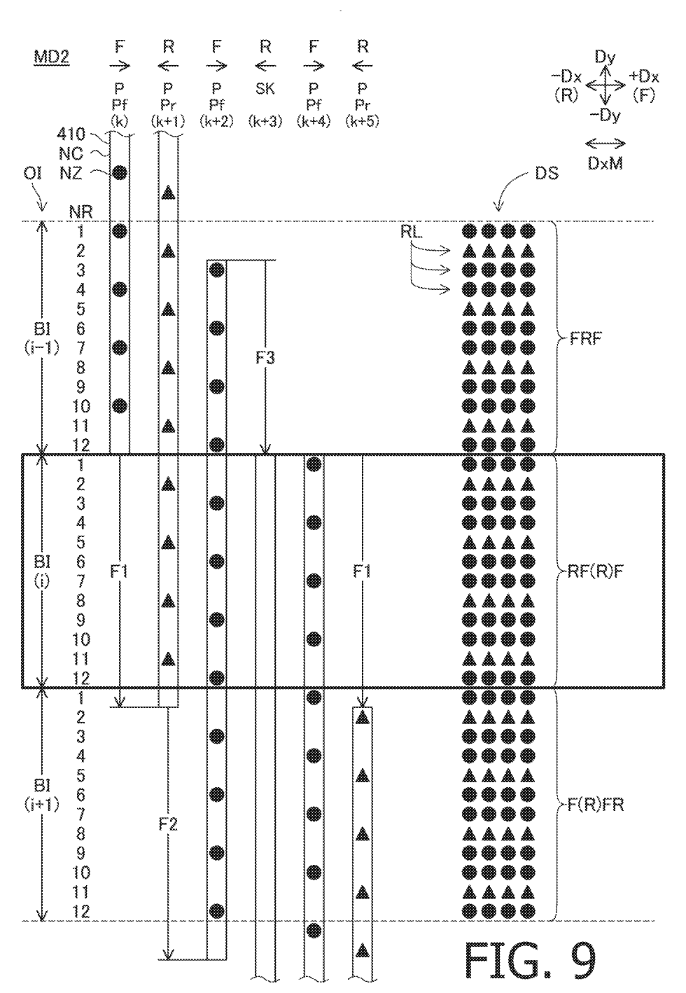

FIG. 9 is a diagram illustrating a relationship between a pass process and nozzle positions in the conveying direction.

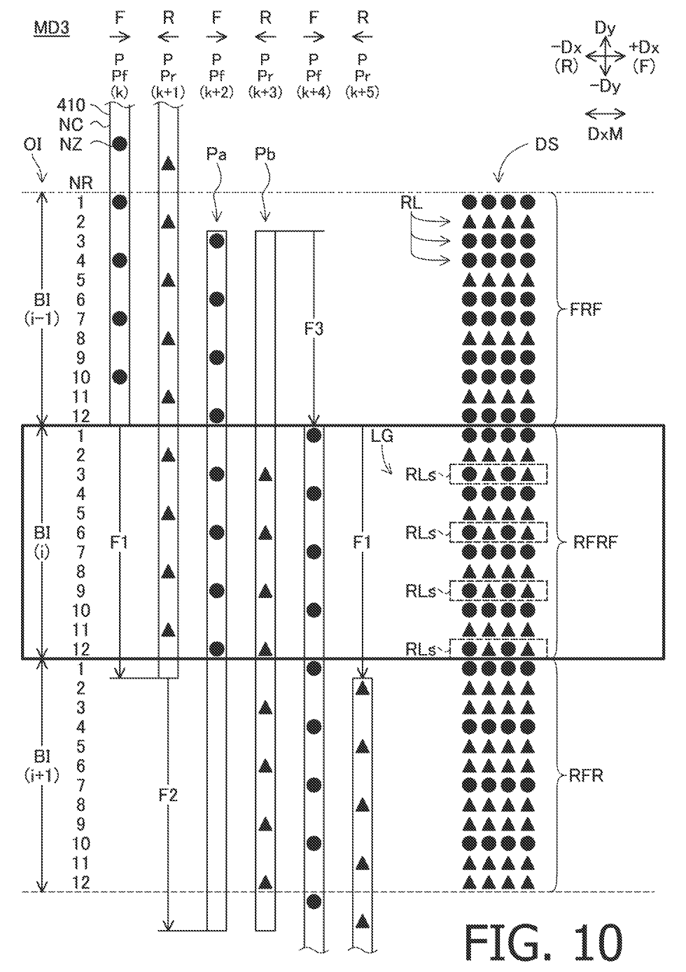

FIG. 10 is a diagram illustrating a relationship between a pass process and nozzle positions in the conveying direction.

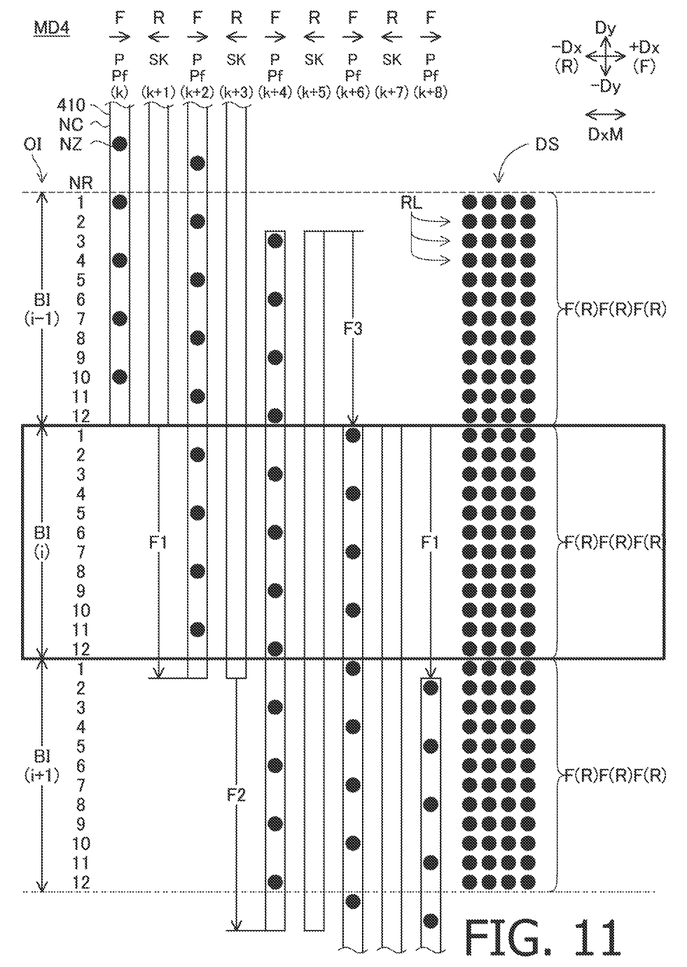

FIG. 11 is a diagram illustrating a relationship between a pass process and nozzle positions in the conveying direction.

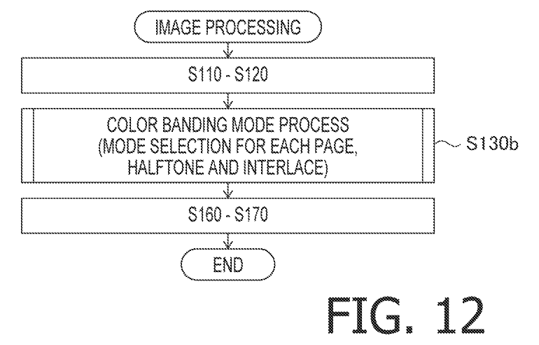

FIG. 12 is a flowchart illustrating another example of image processing.

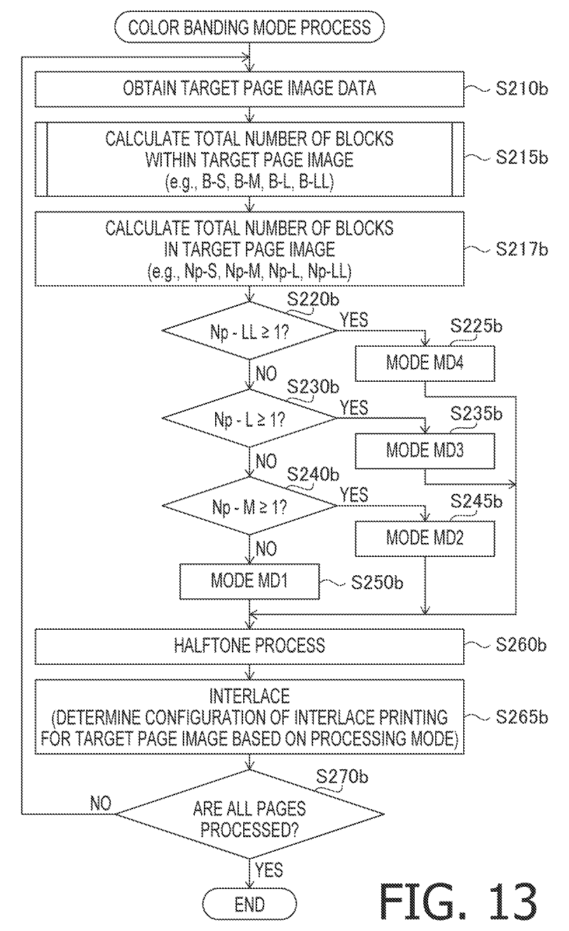

FIG. 13 is a flowchart illustrating an example of a color banding mode process.

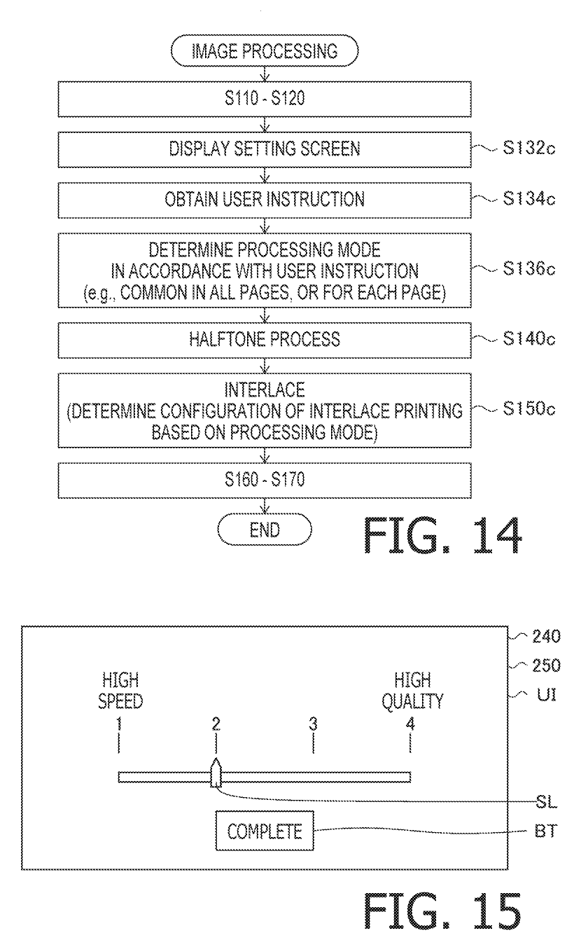

FIG. 14 is a flowchart illustrating a third embodiment of image processing.

FIG. 15 shows an example of a setting screen.

### DESCRIPTION

FIG. 1 is a block diagram illustrating a functional configuration of an MFP (multi-function peripheral) 200 which is an embodiment of a printing device according to the present disclosure. The MFP 200 includes a controller 299, a scanner 280, and a print engine 400. The controller 299 includes a processor 210, a storage device 215, a display 240, an operation panel 250, and a communication interface 270. These components are interconnected through a bus. The storage device 215 includes a volatile storage device 220 and a non-volatile storage device 230.

The processor 210 is a hardware component configured to perform data processing. An example of the processor 210 is a CPU (Central Processing Unit) or a SoC (System on a Chip). An example of the volatile storage device 220 is a DRAM (Dynamic Random Access Memory), and an example of the non-volatile storage device 230 is a flash memory. The non-volatile storage device 230 stores a program 232 and color evaluation information DB (database). In the present embodiment, the program 232 and the color evaluation information DB are prestored in the non-volatile storage device 230 as firmware by a manufacturer of the MFP 200.

It should be understood that, throughout this specification and the claims, the terms "unit" and "section" are intended to refer to hardware-based components, assemblies, or structural elements, unless expressly indicated otherwise. In this context, "unit" may refer to a discrete hardware component or device including one or more physical elements, and "section" may refer to a defined portion of such a structure or component.

The display 240 is a hardware component such as a liquid crystal display (LCD) or an organic electroluminescent (EL) display and is configured to display images. The operation panel 250 is a hardware component configured to receive user operations, and may include buttons, levers, or a touch panel overlaid on the display 240. The display 240 and the operation panel 250 may constitute a so-called touchscreen.

A user may input various requests and instructions into the MFP 200 by operating the operation panel 250. The display 240 may be configured to display operational elements, such as buttons and sliders, which may be operated through the operation panel 250. The communication interface 270 is an interface for communication with external devices, and may include one or more of a USB interface, a wired LAN interface, and a wireless interface compliant with IEEE 802.11.

The scanner 280 is an image reading device configured to optically read an object, such as an original document, using a photoelectric conversion element such as a CCD (charge-coupled device) or a CMOS (complementary metal-oxide semiconductor). The scanner 280 generates scan data (e.g., RGB bitmap data) representing a read image (hereinafter referred to as a "scanned image").

The print engine 400 is a hardware component configured to print images on a sheet PM, which is an example of a printing medium. In the present embodiment, the print engine 400 includes a print head 410 (also referred to simply as the "head 410"), a head driving unit 420, a conveying mechanism 430, a moving mechanism 440, an ink supplying unit 450, and a control circuit 490 configured to control these components 410 to 450. In the present embodiment, the print engine 400 is an inkjet-type printing device that uses inks of cyan (C), magenta (M), yellow (Y), and black (K). The control circuit 490 is an electric circuit configured to control components such as a motor, which will be described later. The control circuit 490 may be implemented using, for example, a computer or dedicated hardware such as an ASIC (Application Specific Integrated Circuit).

The controller 299 is configured to generate print data using image data, and to cause the print engine 400 to print an image using the generated print data. The controller 299 may use scan data or image data stored in an external storage device (e.g., a memory card connected to the communication interface 270) to generate the print data. Further, the controller 299 may cause the print engine 400 to print an image using print data supplied from an external device connected to the MFP 200.

FIG. 2 schematically illustrates a configuration of the print engine 400. The moving mechanism 440 is configured to move the head in both directions parallel to a direction Dx. Hereinafter, the two directions parallel to the direction Dx are collectively referred to as a moving direction DxM. The moving direction DxM includes both the direction Dx and a direction opposite to Dx. In the present description, the direction Dx is also referred to as a +Dx direction, and the opposite direction is referred to as a -Dx direction (e.g., see FIG. 3). Furthermore, the +Dx direction is referred to as a forward direction F, and the -Dx direction is referred to as a reverse direction R (FIG. 3). Other directions may also be expressed using "+" and "−" symbols to indicate respective directions and their opposites.

In the present embodiment, the moving mechanism 440 includes a carriage 443, a sliding shaft 444, a belt 445, and pulleys 446 and 447. The carriage 443 carries the head 410. The sliding shaft 444 extends in the moving direction DxM and is configured to support the carriage 443 so that the carriage 443 is slidable in the moving direction DxM. The belt 445 is looped around the pulleys 446 and 447, and a portion of the belt 445 is fixed to the carriage 443. The pulley 446 is rotated by a motor (not shown), which will be referred to as a head motor. When the head motor rotates the pulley 446, the belt 445 moves, and thereby, the carriage 443 is moved along the sliding shaft 444. As a result, the head 410 moves in the moving direction DxM relative to the sheet PM. Hereinafter, processing for moving the head 410 in the moving direction DxM is referred to as a moving process.

The conveying mechanism 430 is configured to convey the sheet PM in the direction Dy relative to the head 410 while holding the sheet PM. Hereinafter, the direction Dy is also referred to as the conveying direction Dy. The above-mentioned direction Dx (and accordingly, the moving direction DxM) is a direction that intersects the conveying direction Dy. In the present embodiment, the conveying direction Dy is perpendicular to the direction Dx.

In the present embodiment, the conveying mechanism 430 includes a platen PT configured to support the sheet PM, a first roller 431 and a second roller 432 configured to hold the sheet PM placed on the platen PT, and a motor (not shown) configured to drive the rollers 431 and 432. The platen PT is disposed at a position facing the ink ejection surface of the head 410. A direction Dz in the drawings represents a direction from the platen PT toward the head 410. In the present embodiment, the direction Dz is perpendicular to both the direction Dx and the direction Dy.

The first roller 431 is arranged in the −Dy direction relative to the print head 410, and the second roller 432 is arranged in the +Dy direction relative to the print head 410. A sheet PM is supplied from a sheet tray by a sheet feed roller (not shown) to the conveying mechanism 430. The supplied sheet PM is sandwiched between the first roller 431 and a driven roller (not shown) that is paired with the first roller 431, and is conveyed in the conveying direction Dy by this roller pair. The conveyed sheet PM is further sandwiched between the second roller 432 and another driven roller (not shown) that is paired with the second roller 432, and is further conveyed in the conveying direction Dy by this roller pair. The conveying mechanism 430 conveys the sheet PM in the conveying direction Dy by driving the rollers 431 and 432 using power from a motor (hereinafter referred to as the conveying motor). Hereinafter, the process of moving the sheet PM in the conveying direction Dy is referred to as a conveying process.

The ink supplying unit 450 is configured to supply ink to the head 410. The ink supplying unit 450 includes a cartridge mounting section 451, tubes 452, and a buffer tank 453. Ink cartridges KC, YC, CC, and MC for black (K), yellow (Y), cyan (C), and magenta (M) inks are detachably mounted on the cartridge mounting section 451. The buffer tank 453 is attached to the carriage 443. The buffer tank 453 is positioned above the head 410 and temporarily stores the K, Y, C, and M inks to be supplied to the head 410, one for each color. The tubes 452 are flexible tubes that connect the cartridge mounting section 451 with the buffer tank 453. Ink in each of the ink cartridges KC, YC, CC, and MC is supplied to the head 410 via the cartridge mounting section 451, the tubes 452, and the buffer tank 453.

FIG. 3 schematically illustrates a configuration of the head 410 as viewed along the −Dz direction. In FIG. 3, unlike in FIG. 2, the conveying direction Dy of the sheet PM is oriented upward. On a nozzle forming surface 411, which is a surface on the −Dz side of the head 410, nozzle groups NK, NY, NC, and NM are formed to eject the K, Y, C, and M inks, respectively. Each of the nozzle groups NK, NY, NC, and NM includes Nnz nozzles NZ, where Nnz is an integer equal to or greater than two. The Nnz nozzles NZ in one nozzle group are arranged at different positions in the conveying direction Dy. The nozzle groups NK, NY, NC, and NM are arranged at different positions in the Dx direction. In the present embodiment, the nozzle groups NK, NY, NC, and NM are arranged in this order in the +Dx direction.

In the present embodiment, multiple nozzles NZ in one nozzle group are evenly arranged at a nozzle pitch NP in the conveying direction Dy. The nozzle pitch NP refers to a difference in position, in the conveying direction Dy, between two adjacent nozzles NZ. In the present embodiment, the positions of the nozzles NZ in the conveying direction Dy are the same among the four nozzle groups NK, NY, NC, and NM.

A nozzle resolution Rnz indicated in FIG. 3 represents a density of the nozzles NZ in the conveying direction Dy (with a unit of, for example, nozzles per inch). The nozzle resolution Rnz corresponds to the nozzle pitch NP. For example, the nozzle resolution Rnz may be 100 nozzles per inch or 300 nozzles per inch.

Each nozzle NZ is connected to the buffer tank 453 (FIG. 2) via an ink flow passage (not shown) formed inside the head 410. Each ink flow passage is provided with an actuator (not shown), such as a piezoelectric element or a heater, for ejecting ink.

The head driving unit 420 (FIG. 1) includes an electric circuit configured to drive the actuators inside the head 410 while the head 410 is being moved by the moving mechanism 440. Each actuator ejects ink from the corresponding nozzle NZ toward the sheet PM, whereby dots are formed on the sheet PM.

### Overview of Printing Process

FIG. 4 is a diagram illustrating an overview of printing performed by the print engine 400. In FIG. 4, the sheet PM and an objective image OI, which is an image to be printed on the sheet PM, are illustrated. The objective image OI is represented by multiple raster lines RL arranged in the conveying direction Dy. Each raster line RL extends in the moving direction DxM. One nozzle NZ (FIG. 3) can form dots on one raster line RL by ejecting ink while the head 410 is being moved by the moving mechanism 440 (FIG. 2). In the present embodiment, four nozzles for ejecting K, Y, C, and M inks are capable of forming dots on a single raster line RL. Hereinafter, a process of forming multiple dots on a raster line RL by driving the print head 410 during its movement will be referred to as a dot-forming pass process, or simply a pass process. One pass process can form multiple dots on multiple raster lines RL arranged in the conveying direction Dy at the nozzle resolution Rnz (FIG. 3).

The multiple raster lines RL are arranged at equal intervals in the conveying direction Dy. A line resolution Rrl shown in FIG. 4 represents the density of the raster lines RL in the conveying direction Dy, and is indicated in a unit of, for example, lines per inch. In the present embodiment, the line resolution Rrl is determined by multiplying the nozzle resolution Rnz (FIG. 3) by a resolution multiplier N, where N is an integer equal to or greater than two. The resolution multiplier N may take various values. In the following description, it is assumed that the resolution multiplier N equals three. Accordingly, when the nozzle resolution Rnz is 100 lines per inch, the line resolution Rrl is 300 lines per inch. When the nozzle resolution Rnz is 300 lines per inch, the line resolution Rrl is 900 lines per inch.

The dot resolution in the moving direction DxM may be set independently of the line resolution Rrl in the conveying direction Dy (i.e., the dot resolution in the conveying direction Dy). For example, the dot resolution in the moving direction DxM may be 600 dpi (dots per inch) or 1200 dpi.

The objective image OI includes multiple band images BI1 to BIn that are arranged from the +Dy-side edge toward the −Dy direction of the objective image OI. As will be described later, in the present embodiment, the controller 299 is configured to select a processing mode for printing each band image by the print engine 400. Each of the band images BI1 to BIn has a rectangular shape extending in the moving direction DxM. The band images BI1 to BIn have the same size in the conveying direction Dy. Each of the band images BI1 to BIn includes multiple raster lines RL. A number Nrl indicated in FIG. 4 represents the total number of raster lines RL included in one band image. In the example shown in FIG. 4, adjacent band images are arranged in the conveying direction Dy without overlapping and without any gap therebetween.

As described above, in the present embodiment, the line resolution Rrl is N times the nozzle resolution Rnz. In this case, the total number Nrl of raster lines RL included in one band image may be a multiple of N. In the present embodiment, it is assumed that one pass process can form dots in an area covering N consecutive band images. In this case, the total number Nnz of nozzles NZ included in one nozzle group (FIG. 3) may be equal to the total number of raster lines RL included in the N band images (i.e., N*Nrl/N = Nrl), that is, Nnz = Nrl. The head 410 configured as shown in FIG. 4 can form dots in an area covering three band images BI2 to BI4 by one pass process. Further, one pass process can form dots in Nrl⁄N raster lines RL out of the Nrl raster lines in one band image. That is, the multiple dots for the Nrl raster lines RL of one band image are formed through N or more pass processes. A method of printing multiple consecutive raster lines in the conveying direction Dy through multiple pass processes is referred to as interlace printing.

As pass processes, a process of moving the head 410 in the +Dx direction (i.e., the forward direction F) and a process of moving the head 410 in the −Dx direction (i.e., the reverse direction R) are available. Hereinafter, the pass process in the forward direction F is referred to as a forward pass process, and the pass process in the reverse direction R is referred to as a reverse pass process. Printing that alternately repeats the forward pass process and the reverse pass process is referred to as bidirectional printing. The bidirectional printing enables higher-speed image printing compared to printing in which dots are formed using only one of the forward pass process or the reverse pass process.

The multiple band images BI1 to BIn are printed in order from the band image BI1 at the +Dy-side end of the objective image OI toward the −Dy direction. When the bidirectional printing is performed, as described below, noticeable differences in color appearance (i.e., the perceived colors) may occur among multiple band images that represent the same color. The phrase "multiple band images represent the same color" means that the colors of the respective band images, as indicated by the data of the objective image, are the same.

Between the forward pass process and the reverse pass process, the order in which multiple types (colors) of inks are overlaid is different. In the embodiment shown in FIG. 3, the ink overlay order in the forward pass process is M, C, Y, and K, whereas the ink overlay order in the reverse pass process is K, Y, C, and M. If the ink overlay order differs between two portions of a printed image that represent the same color, an observer of the printed image may perceive a difference in color between the two portions (i.e., the two portions may exhibit different color appearances). For example, the raster lines RL on which dots are formed by the forward pass process and those on which dots are formed by the reverse pass process may exhibit different color appearances.

When the bidirectional printing is performed, the number of forward pass processes and the number of reverse pass processes may differ among multiple band images. For example, the band image BI2 (FIG. 4) may be printed through two forward pass processes and one reverse pass process, whereas the adjacent band image BI3 may be printed through one forward pass process and two reverse pass processes. In such a case, even if the band images BI2 and BI3 are intended to represent the same color, they may appear to have different colors. That is, an observer of the printed image may perceive a band-shaped area exhibiting an inappropriate color. Such band-shaped unevenness in color is known as a phenomenon called "banding." The degree of differences in the perceived color appearance caused by differences in the direction of the pass process may vary depending on the color to be printed. As will be described later, the processor 210 is configured to cause the print engine 400 to print each band image using a processing mode appropriate for the band image, so as to reduce the possibility that band images representing the same color will be perceived as having different color appearances.

### Image Processing

FIG. 5 is a flowchart illustrating an example of image processing for printing. The processor 210 starts the processing shown in FIG. 5 in response to a print instruction, and performs the processing in accordance with the program 232. In S110, the processor 210 obtains the print instruction and generates target image data in accordance with the print instruction. The print instruction may be obtained by any available method. In the present embodiment, the print instruction is input by the user operating the operation panel 250 (FIG. 1). Alternatively, the processor 210 may obtain the print instruction from another device (e.g., a computer, a smartphone, or the like) connected to the MFP 200.

The print instruction includes information for designating image data (hereinafter referred to as input image data). The input image data may take various forms and may be, for example, image data that has already been stored in the storage device 215 (e.g., the non-volatile storage device 230). The processor 210 generates target image data based on the input image data.

In the present embodiment, bitmap data having a processing resolution is used as the data of the objective image OI. It is assumed that each pixel value of the target image data is represented by 256-level color values of R (red), G (green), and B (blue). The processing resolution is set to a resolution used for printing by the print engine 400, with the unit being, for example, ppi (pixels per inch). The processing resolution represents the pixel density in the moving direction DxM (FIG. 4) and in the conveying direction Dy. It also represents a resolution suitable for the density of multiple dots formed by the print engine 400. For example, the processing resolution may be the same as the resolution representing the dot density.

The input image data may be vector data including drawing commands for rendering objects. In such a case, the processor 210 may generate target image data by rendering (also referred to as rasterizing) the vector data. If the input image data is bitmap data, the processor 210 may generate target image data having the processing resolution by performing resolution conversion on the bitmap data.

In S120, the processor 210 performs a color conversion process on the target image data. The color conversion process converts the color values of individual pixels from a source color space (which is the RGB color space in the present embodiment) to a printing color space. The printing color space is defined by color components corresponding to the color materials used by the print engine 400, and in the present embodiment, the printing color space is the CMYK color space. The correspondence between the color values in the source color space and those in the printing color space is predetermined. The processor 210 stores the color-converted target image data in the storage device 215 (e.g., the volatile storage device 220).

In S130, the processor 210 performs a color banding mode process. In this process, the processor 210 determines a configuration of the interlace printing so that the possibility of banding being visually perceived is reduced. Specifically, the processor 210 determines the configuration of the pass process and the conveying process so that the resulting banding is less noticeable.

FIG. 6 is a flowchart illustrating an example of the color banding mode process. In S210, the processor 210 selects an unprocessed band image, among the multiple band images BI1 to BIn included in the objective image OI (see FIG. 4), as a target band image. Then, the processor 210 obtains data of the target band image from both the target image data and the color-converted target image data. The order in which the target band images are selected may be arbitrary. For example, the processor 210 may sequentially select the band images from BI1 at the +Dy-side end of the objective image OI toward the −Dy direction.

In S215, the processor 210 calculates the degree of banding for each block in the target band image. FIGS. 7A to 7D illustrate examples of processing performed on the target band image. FIG. 7A is a flowchart illustrating an example of a process for determining the degree of banding of a single block (hereinafter referred to as a banding degree determining process). FIG. 7B illustrates the i-th band image BI(i) and the (i+1)-th band image BI(i+1) included in the objective image OI. In the present embodiment, each band image is composed of multiple blocks BL arranged in a grid pattern along the +Dx direction and the +Dy direction. The size of each block BL and the arrangement of the blocks within the band image are predetermined.

For ease of explanation, FIG. 7A is described as a subroutine that executes the process in S215 (i.e., the color banding mode process). However, it should be understood that the process shown in FIG. 7A is not limited to being implemented as a subroutine, and may instead be integrated into a sequence of steps between S210 and S217.

In S310 (FIG. 7A), the processor 210 calculates a ratio RdL of attention pixels within the currently processed block. The processor 210 determines whether each pixel included in the block BL is an attention pixel by referring to the color evaluation database (FIG. 7C). In the present embodiment, the color evaluation database defines a correspondence between color values (in this case, RGB values) and flags FL. A flag FL having a value Tr (true) indicates that the color difference dL is greater than a threshold dLTh, while a flag FL having a value Fls (false) indicates that the color difference dL is equal to or less than the threshold dLTh. An attention pixel is a pixel having a color value associated with a flag FL whose value is Tr (true). The color difference dL is calculated as described below.

In the present embodiment, based on color values (in this case, RGB values), a first patch is printed through a forward pass process, and a second patch is printed through a reverse pass process based on the same color values. Each patch is a uniform color area represented by the same color values. The order in which multiple types of inks are overlaid differs between the two patches. The patches are measured using a colorimeter, and the L* values in the CIELAB color space are obtained. The color difference dL is defined as the absolute value of the difference between the L* values of the two patches. The threshold dLTh is experimentally determined in advance such that the color difference dL is greater than the threshold dLTh when the color difference between the two patches is easily perceived by an observer, and equal to or less than the threshold dLTh when the color difference is not easily perceived.

In the present embodiment, the color evaluation database defines the correspondence for all combinations of RGB values (i.e., 256 * 256 * 256 combinations). Printing of patches and color measurement may be performed for a subset of these combinations. For example, the gradation values of R, G, and B used for printing the patches may be selected from 16 values obtained by evenly dividing the range from 0 to 255. That is, printing, color measurement, and calculation of the color difference dL may be performed for 16 * 16 * 16 combinations of RGB values. The color difference dL for the other combinations may then be calculated by interpolation. The color evaluation database may be prepared in advance by a manufacturer of the MFP 200.

In S310 (FIG. 7A), the processor 210 refers to the color evaluation database to identify the respective flags FL for the multiple pixels included in the block BL. The processor 210 then calculates a ratio RdL of attention pixels, which are pixels associated with a flag FL having the value Tr (true), to the total number of pixels in the block BL.

In S320, the processor 210 determines whether the ratio RdL is equal to or greater than a very large threshold th-LL. If the ratio RdL is equal to or greater than the very large threshold th-LL (S320: YES), the processor 210 determines the degree of banding of the block BL to be very large B-LL in S325, and terminates the process shown in FIG. 7A.

If the radio RdL is less than the very large threshold th-LL (S320: NO), the processor 210 determines whether the ratio RdL is equal to or greater than large threshold th-L in S330. If the ratio RdL is equal to or greater than the large threshold th-L (S330: YES), the processor 210 determines the degree of banding or the block BL to be large B-L in S335, and terminates the process shown in FIG. 7A (i.e., proceeds to S217 of FIG. 6).

If the ratio RdL is less than the large threshold th-L (S330: NO), the processor 210 determines in S340 whether the ratio RdL is equal to or greater than a medium threshold th-M. If the ratio RdL is equal to or greater than the medium threshold th-M (S340: YES), the processor 210 determines the degree of banding of the block BL to be medium B-M in S345, and terminates the process shown in FIG. 7A (i.e., proceeds to S217 of FIG. 6).

If the ratio RdL is less than the medium threshold th-M (S340: NO), the processor 210 determines, in S355, the degree of banding of the block BL to be small B-S, and terminates the process shown in FIG. 7A (i.e., proceeds to S217 of FIG. 6).

The thresholds th-LL, th-L, and th-M may be various values as long as the relationship "th-LL > th-L > th-M" is satisfied. These thresholds are experimentally determined in advance such that the degree of banding appropriately reflects the perceptible difference in color when the block BL is printed through a forward pass process and a reverse pass process. For example, the very large threshold th-LL may be 5%, the large threshold th-L may be 4%, and the medium threshold th-M may be 3%.

As described above, in S215 of FIG. 6 (i.e., FIG. 7A), the processor 210 calculates the degree of banding for each block BL included in the target band image. The degrees of banding of the blocks BL in the target band image collectively represent the degree of banding of the target band image.

In S217, the processor 210 calculates the total number of each type of block in the target band image. In the present embodiment, the processor 210 calculates the total numbers N-S, N-M, N-L, and N-LL of blocks whose degrees of banding are small B-S, medium B-M, large B-L, and very large B-LL, respectively. The greater the degree of banding of the blocks included in the target band image, the more likely the target band image is to exhibit banding. In S220 to S250, the processor 210 selects an interlace printing processing mode for the target band image from among four available modes, MD1 to MD4.

FIGS. 8 to 11 illustrate the pass processes and the positions of the nozzles NZ in the conveying direction Dy. FIGS. 8 to 11 correspond to the modes MD1 to MD4, respectively.

Each of FIGS. 8 to 11 illustrates three band images, BI(i–1), BI(i), and BI(i+1), which are continuously arranged in the conveying direction Dy. In each figure, the right-hand side corresponds to the +Dx direction (i.e., the forward direction F), and the upward direction corresponds to the conveying direction Dy. It is assumed that the i-th band image BI(i) is the target band image. The (i–1)-th band image BI(i–1) is an adjacent band image that is printed before the target band image BI(i) is printed, and the (i+1)-th band image BI(i+1) is an adjacent band image that is printed after the target band image BI(i) is printed.

Each of FIGS. 8 to 11 shows the positions of the print head 410 and the multiple nozzles NZ in the conveying direction Dy during a k-th moving process (where k is an integer) and during multiple moving processes subsequent to the k-th moving process. Each moving process is either a pass process P, in which dots are formed, or a skip process SK, in which the print head 410 is moved without forming dots. The pass process P is either a forward pass process Pf, which is a pass process performed in the forward direction F, or a reverse pass process Pr, which is a pass process performed in the reverse direction R. Above each symbol "P" or "SK," a symbol indicating the moving direction of the print head 410—either "F" for the forward direction or "R" for the reverse direction—is shown. Within each depiction of the print head 410 during a pass process P, multiple nozzles NZ of the nozzle group NC are illustratively shown. Circle symbols and triangle symbols each represent a nozzle NZ; the circle symbol represents a nozzle used in the forward pass process Pf, and the triangle symbol represents a nozzle used in the reverse pass process Pr. Raster line numbers NR shown in the drawings indicate the indices of the raster lines RL within the band image, and are assigned in ascending order toward the −Dy direction.

As described above, the line resolution Rrl is N times the nozzle resolution Rnz. In the examples shown in FIGS. 8 to 11, N is assumed to be 3. The total number Nrl of raster lines RL included in one band image may be set to a multiple of N. In these examples, Nrl = 12. Further, the total number Nnz of nozzles NZ included in one nozzle group is set to be equal to the total number Nrl of raster lines RL (i.e., Nnz = Nrl = 12). One pass process P can form dots over an area covering three consecutive band images.

In each of FIGS. 8 to 11, conveying amounts F1, F2, and F3 are shown, each indicating the amount of sheet conveyance between two successive positions of the print head 410 corresponding to two consecutive moving processes. The conveying amounts F1, F2, and F3 represent the amounts by which the sheet PM is conveyed during the conveying processes performed between the respective moving processes. For example, in the case of FIG. 8, the conveying process with the first conveying amount F1 is performed between the k-th pass process P and the (k+1)-th pass process P. The conveying amounts F1, F2, and F3 are determined in advance such that each pass process P forms dots on raster lines RL different from those printed by other pass processes. In the examples shown in FIGS. 8 to 11, printing of the raster lines RL of the objective image OI is carried out by repeatedly executing conveying processes with three types of conveying amounts: F1 = 13, F2 = 13, and F3 = 10.

One nozzle NZ can print one raster line RL extending in the moving direction DxM by a single pass process P. On the right-hand side of each of FIGS. 8 to 11, a directional pattern DS is shown. The directional pattern DS indicates the correspondence between each raster line RL and the moving direction of the print head 410 during dot formation. Each raster line is represented by four symbols corresponding to four nozzles NZ, which in turn represent four dots as a representative subset of the multiple dots formed along the raster line. For example, in FIG. 8, the first raster line RLa of the target band image BI(i) is represented by four triangular symbols, indicating that the multiple dots of this raster line RLa are formed by the reverse pass process Pr.

On the right-hand side of the directional pattern DS, the sequence of moving directions (i.e., the forward direction F and the reverse direction R) of the print head 410 in the multiple moving processes for printing a band image is shown. This sequence of moving directions associated with the band image is hereinafter referred to as the "moving order." For example, the moving order for the target band image BI(i) in FIG. 8 is "RFR," which indicates that the band image BI(i) is printed by three pass processes P executed in the order of reverse direction R, forward direction F, and reverse direction R. A moving direction enclosed in parentheses indicates the direction of a skip process SK. For instance, the moving order for the target band image BI(i) shown in FIG. 9 is "RF(R)," indicating that the third moving process is a skip process SK in the reverse direction.

Next, details of the respective modes MD1 to MD4 will be described. A high-speed mode MD1 (FIG. 8) is a mode in which bidirectional printing is performed. Specifically, the high-speed mode MD1 is a processing mode in which the print engine 400 is caused to perform N pass processes, involving alternate execution of a forward pass process Pf and a reverse pass process Pr. In the example shown in FIG. 8, the target band image BI(i) is printed by three pass processes P executed in the moving order "RFR". In the high-speed mode MD1, the forward pass process Pf and the reverse pass process Pr are executed alternately. After each pass process P, a conveying process is performed. The conveying amounts F1, F2, and F3 are cyclically repeated over multiple conveying processes. In the example of FIG. 8, it is assumed that both adjacent band images BI(i−1) and BI(i+1) are also printed in the high-speed mode MD1.

In the high-speed mode MD1, the target band image BI(i) is printed through three pass processes P, with a conveying process performed between each pair of consecutive pass processes P. Accordingly, the target band image BI(i) is printed at high speed.

When multiple band images consecutive in the conveying direction Dy are printed in the high-speed mode MD1, the movement orders RFR and FRF are alternately repeated. Between two adjacent band images, the number of forward pass processes Pf and the number of reverse pass processes Pr differ. That is, the difference obtained by subtracting the number of reverse pass processes Pr from the number of forward pass processes Pf (hereinafter referred to as the directional difference) varies between adjacent band images. Accordingly, if a band image includes a block BL exhibiting a large degree of banding (e.g., very large B-LL or large B-L (FIG. 7A)), the banding may become noticeable.

A semi-high-speed mode MD2 (FIG. 9) is a processing mode in which the print engine 400 is caused to perform N pass processes P along with one or more skip processes SK inserted between the pass processes. In the example shown in FIG. 9, a band image is printed by four moving processes including three pass processes P and one skip process SK inserted between them. For printing the target band image BI(i), four moving processes are performed in the moving order of "RF(R)F". Among these four moving processes, three—namely, R, F, and F—are pass processes P by which dots are formed. After each pass process P, a conveying process is performed. No conveying process is performed between the skip process SK and the succeeding pass process P. Alternatively, the conveying process between the skip process SK and the preceding pass process P may be omitted, and the conveying process may be performed after the skip process SK and before the succeeding pass process P. In the example shown in FIG. 9, the adjacent band image BI(i–1) is printed in the high-speed mode MD1, while the band image BI(i+1) is printed in the semi-high-speed mode MD2.

In the semi-high-speed mode MD2 according to the present embodiment, one skip process SK is executed among three pass processes P. Accordingly, between the target band image BI(i) printed in the semi-high-speed mode MD2 and the adjacent band image BI(i–1) printed in the high-speed mode MD1, the number of forward pass processes Pf is the same, and the number of reverse pass processes Pr is also the same (in the example shown in FIG. 9, the number of forward pass processes Pf is two, and the number of reverse pass processes Pr is one). Therefore, the likelihood that banding becomes noticeable between the target band image BI(i) and the adjacent band image BI(i–1) is reduced.

Various positions may be selected for inserting the skip process SK during the N pass processes P for the target band image. For example, when the target band image that follows a band image printed in the high-speed mode MD1 is to be processed in the semi-high-speed mode MD2, the skip process SK may be inserted after the last pass process P for the preceding band image. In the example shown in FIG. 9, the skip process SK is inserted after the last pass process P(k+2) for the preceding band image BI(i–1). In this way, a quick transition from printing a band image in the high-speed mode MD1 to printing the next band image in the semi-high-speed mode MD2 can be achieved.

A semi-high-quality mode MD3 (FIG. 10) is a mode in which bidirectional printing is performed. Unlike the high-speed mode MD1, some of the raster lines RL are printed through multiple pass processes P. The number of pass processes in the semi-high-quality mode MD3 is greater by one compared to that in the high-speed mode MD1. In the present embodiment, the target band image is printed by four pass processes P.

In the present embodiment, as explained with reference to FIG. 8, when it is assumed that N pass processes P are performed in the high-speed mode MD1, the number of forward pass processes Pf is either one greater than or one less than the number of reverse pass processes Pr. The (N+1) pass processes P in the semi-high-quality mode MD3 are formed by dividing one pass process P—corresponding to the lesser of the forward and reverse directions—into two pass processes executed in both directions. As a result, the direction of the final pass process P is reversed.

In the example shown in FIG. 10, if the target band image BI(i) were to be printed in the high-speed mode MD1, the movement order would be R-F-R. In the semi-high-quality mode MD3, the second pass process in this sequence is divided into two bidirectional pass processes. Consequently, the direction of the final pass process changes from the reverse direction R to the forward direction F. Accordingly, the target band image BI(i) is printed through four pass processes P(k+1) to P(k+4), executed in the movement order R-F-R-F. Oppositely, if the target band image BI(i) were to be printed in the high-speed mode MD1 with the movement order of F-R-F, in the semi-high-quality mode MD3, the second pass process in this sequence is also divided into two bidirectional pass processes. Consequently, the direction of the final pass process changes from the reverse direction F to the forward direction R. Accordingly, the target band image BI(i) is printed through four pass processes P(k+1) to P(k+4), executed in the movement order F-R-F-R. Thus, in either case, the semi-high-quality mode MD3 is configured to cause the print engine 400 to perform printing of the band image by multiple pass processes including the preceding pass process and the succeeding pass process starting from the +Dx direction, and printing of the band image by multiple pass processes including the preceding pass process and the succeeding pass process starting from the -Dx direction.

The second pass process P(k+2) and the third pass process P(k+3) form dots on the same group of raster lines RLs. No conveying process is performed between these two pass processes. Hereinafter, this group of raster lines RLs is referred to as a partial line group LG. In the example of FIG. 10, the band images BI(i−1) and BI(i+1) are printed in the high-speed mode MD1.

Between two pass processes P(k+2) and P(k+3) that form dots on a common group of raster lines RLs, the preceding pass process P(k+2) forms dots on a predetermined partial area of the raster lines RLs. The succeeding pass process P(k+3) forms dots on the remaining area of the raster lines RLs. In this way, the preceding pass process P(k+2) forms a portion of the multiple dots to be formed on the raster lines RLs, and the succeeding pass process P(k+3) forms the remaining portion of the multiple dots.

The areas on which the dots are to be recorded by the preceding and succeeding pass processes may be defined in various ways. For example, the allocation of the two areas may be determined using different mask patterns (e.g., mask patterns having so-called blue noise characteristics). Alternatively, the two areas may be arranged alternately and periodically along the direction Dx.

As described above, even between two portions of a printed image that are supposed to represent the same color, their appearance may differ to a human observer. For example, the appearance of a raster line RL in which all dots are formed by a forward pass process Pf may differ significantly from that of a raster line RL in which all dots are formed by a reverse pass process Pr.

In multiple raster lines RLs, dots are formed by both a preceding pass process P(k+2) and a succeeding pass process P(k+3) performed in the direction opposite to that of the preceding pass process. That is, dots on such raster lines RLs are formed by both the forward pass process Pf and the reverse pass process Pr. These raster lines will hereinafter also be referred to as bidirectional raster lines RLs.

In such bidirectional raster lines RLs (i.e., the partial line group LG), the likelihood that their perceived color is biased toward the perceived color produced solely by the forward pass process Pf is reduced. Similarly, the likelihood that their perceived color is biased toward the perceived color produced solely by the reverse pass process Pr is also reduced. Accordingly, a band image including multiple bidirectional raster lines RLs (e.g., the band image BI(i) shown in FIG. 10) can reduce the likelihood of exhibiting a perceived color difference compared to other band images intended to represent the same color.

For example, as shown in FIG. 8, the difference in the configurations of the band images BI(i−1) and BI(i), both printed in the high-speed mode MD1, is as follows. Specifically, the configuration of the band image BI(i) is the same as that obtained by replacing a part of the raster lines RL associated with the forward direction F in the band image BI(i−1) with raster lines RL associated with the reverse direction R. Accordingly, a significant color difference may be perceived between the printed band images BI(i−1) and BI(i).

On the other hand, as shown in FIG. 10, the difference in configurations of multiple raster lines RL between the band image BI(i−1), which is printed in the high-speed mode MD1, and the band image BI(i), which is printed in the semi-high-quality mode MD3, is as follows. Specifically, the configuration of the band image BI(i) is the same as that obtained by replacing part of the raster lines RL associated with the forward direction F in the band image BI(i−1) with bidirectional raster lines RLs. Compared to a configuration in which the raster lines RL associated with the forward direction F are replaced with raster lines RL associated with the reverse direction R, the perceived color difference between the printed band images BI(i−1) and BI(i) is reduced.

In the semi-high-quality mode MD3, among the multiple raster lines RL of the target band image, the total number of raster lines RL on which dots are formed solely by the forward pass process Pf and the total number of raster lines RL on which dots are formed solely by the reverse pass process Pr are the same (in the example shown in FIG. 10, the number is four for each). In the remaining raster lines RLs of the target band image, dots are formed by both the forward pass process Pf and the reverse pass process Pr. Accordingly, the difference between the total number of dots formed by the forward pass process Pf and that formed by the reverse pass process Pr is reduced. As a result, the perceived color of the band image printed in the semi-high-quality mode MD3 may fall between the color appearances of a band image printed by three pass processes in the FRF order and one printed in the RFR order (FRF and RFR represent movement orders in the high-speed mode MD1 shown in FIG. 8). In this manner, the perceived color difference between a band image printed in the semi-high-quality mode MD3 and a band image printed in the high-speed mode MD1 is less than the perceived color difference between two band images both printed in the high-speed mode MD1 using different movement orders (e.g., FRF versus RFR). Therefore, as illustrated in FIG. 10, when a band image adjacent to the band image BI(i) printed in the semi-high-quality mode MD3 is printed in the high-speed mode MD1, the likelihood that banding will be noticeable between these images is reduced.

Further, in the semi-high-quality mode MD3, no skip process SK is performed, and the forward pass process Pf and the reverse pass process Pr are alternately executed (i.e., bidirectional printing is performed). Accordingly, compared to a case where skip processes SK are additionally performed, the band image can be printed more quickly.

A high-quality mode MD4 (FIG. 11) is a mode in which unidirectional printing is performed. In this mode, the print engine 400 is caused to alternately execute pass processes P and skip processes SK. The number of pass processes P is N, and all N pass processes P are performed in the same direction (i.e., either the forward direction F or the reverse direction R). In the example shown in FIG. 11, in order to print the target band image BI(i), six moving processes are executed in the order of F(R)F(R)F(R). Among these six moving processes, three pass processes P (i.e., FFF) are used to form dots. After each skip process SK, a conveying process is performed. Between the skip process SK and the preceding pass process P, no conveying process is performed. Alternatively, the conveying process between the skip process SK and the preceding pass process P may be omitted, and a conveying process may be performed between the pass process P and the following skip process SK. In the example shown in FIG. 11, the adjacent band images BI(i–1) and BI(i+1) are also printed in the high-quality mode MD4.

In the high-quality mode MD4, the direction of the pass process P for forming dots is set in advance to one direction selected from the forward direction F and the reverse direction R (in the example shown in FIG. 11, the forward direction F). Therefore, when multiple band images that are consecutive in the conveying direction Dy are printed in the high-quality mode MD4, the possibility that banding becomes noticeable among the band images is reduced.

In S220 to S250 of FIG. 6, the processor 210 uses the total numbers N-S, N-M, N-L, and N-LL of the respective types of blocks in the target band image to select a mode suitable for the target band image from among the modes MD1 to MD4.

In S220, the processor 210 determines whether the number N-LL of very large blocks is one or more. If the number N-LL of very large blocks is one or more (S220: YES), the processor 210 selects the high-quality mode MD4 in S225 and proceeds to S260. FIG. 7D illustrates an example of such mode selection. In the example shown in FIG. 7D, the number N-LL of very large blocks in the band image BI(i) is one or more. Accordingly, the high-quality mode MD4 is applied to the band image BI(i). Thus, the processor 210 determines the magnitude of a difference in the perceived color of the band image BI(i) due to the directional variation in the pass processes P. After that, the processor 210 cause the print engine 400 to print based on the magnitude of the difference in the perceived color of the band image BI(i) due to the directional variation in the pass processes P.

If the number N-LL of very large blocks is less than one (FIG. 6, S220: NO), the processor 210 proceeds to S230 and determines whether the number N-L of large blocks is one or more. If the number N-L of large blocks is one or more (S230: YES), the processor 210 selects the semi-high-quality mode MD3 in S235 and proceeds to S260.

If the number N-L of large blocks is less than one (S230: NO), the processor 210 proceeds to S240 and determines whether the number N-M of medium blocks is one or more. If the number N-M of medium blocks is one or more (S240: YES), the processor 210 selects the semi-high-speed mode MD2 in S245 and proceeds to S260.

If the number N-M of medium blocks is less than one (S240: NO), the processor 210 selects the high-speed mode MD1 in S250 and proceeds to S260.

As described above, the processor 210 selects a mode having a higher banding suppression capability when the degree of banding of the blocks BL included in the target band image is larger. Conversely, when the degree of banding of the blocks BL included in the target band image is smaller, the processor 210 selects a mode having a higher capability of improving the printing speed.

In S260, the processor 210 generates print image data by performing a halftone process on the data of the color-converted target band image. The print image data represents a pattern of dots to be formed on the sheet PM (see FIG. 4). The halftone process may be carried out using various techniques, such as an error diffusion method or a method using a dither matrix.

In S265, the processor 210 determines an interlace printing configuration for the target band image based on the print image data of the target band image and the processing mode selected in S220 to S250. As described with reference to FIGS. 8 to 11, the processor 210 determines a configuration of multiple moving processes and multiple conveying processes suitable for the selected processing mode.

It is noted that the processor 210 may adjust the interlace printing configuration of the target band image so as to align the configuration with that of an adjacent band image that is printed before the target band image. It is preferable that multiple dots of the adjacent band image are formed by multiple pass processes P corresponding to the processing mode of the adjacent band image. Likewise, it is preferable that multiple dots of the target band image are formed by multiple pass processes P corresponding to the processing mode of the target band image. The processor 210 may associate the moving processes for the adjacent band image with those for the target band image in order to allow such interlace printing to proceed smoothly.

If, for example, the mode of the adjacent band image is the semi-high-speed mode MD2 (FIG. 9), and the mode of the target band image is the semi-high-quality mode MD3 (FIG. 10), the processor 210 may adopt the last three moving processes out of the four moving processes performed for the adjacent band image as the first three pass processes P for the target band image. Further, if the mode of the adjacent band image is the high-quality mode MD4 (FIG. 11), and the mode of the target band image is the high-speed mode MD1 (FIG. 8), the processor 210 may adopt the third and sixth moving processes out of the six moving processes performed for the adjacent band image as the first two pass processes P for the target band image.

Similarly, for other combinations of modes, the processor 210 may associate the moving processes for the adjacent band image with the moving processes for the target band image such that multiple dots of the band image are formed through multiple pass processes P that correspond to the processing mode of the band image. For appropriate interlaced printing, the processor 210 may insert a skip process SK between two pass processes P. Note that the correspondence between the moving processes for the adjacent band image and those for the target band image may be predetermined for each combination of modes. The processor 210 may refer to data that defines such correspondences to determine the configuration for interlaced printing.

In S270 (FIG. 6), the processor 210 determines whether all of the band images have been processed. If there are any unprocessed band images remaining (S270: NO), the processor 210 proceeds to S210 to process a new band image. If all of the band images have been processed (S270: YES), the processor 210 terminates the processing shown in FIG. 6, that is, the processing of S130 in FIG. 5.

In S160, the processor 210 generates job data using the interlace printing configuration determined in S130. The job data is data represented in a format that can be interpreted by the control circuit 490 of the print engine 400 (FIG. 1). This job data is also referred to as print data. The processor 210 generates the job data, for example, by arranging data representing the dot formation states in the order in which they are used for printing, and by appending a printer control code and a data identification code.

In S170, the processor 210 transmits the job data to the print engine 400. The control circuit 490 of the print engine 400 prints the objective image OI on the sheet PM in accordance with the job data. The control circuit 490 prints each of the multiple band images BI1 to BIn in accordance with the processing mode associated with each band image. Thereafter, the processing shown in FIG. 5 is completed.

It should be noted that the target image data may represent images spanning multiple pages. In such a case, the processor 210 may perform the color banding mode processing (S130) on a per-page basis.

As described above, in the present embodiment, the print engine 400 (FIG. 2) includes the head 410, the conveying mechanism 430, and the moving mechanism 440. The head 410 (FIG. 3) has L nozzle groups NK, NY, NC, and NM for ejecting L types of ink (L = 4 in the present embodiment). The conveying mechanism 430 (FIG. 2) is configured to convey the sheet PM in a conveying direction Dy with respect to the print head 410. The moving mechanism 440 is configured to move the print head 410 in a moving direction DxM that intersects the conveying direction Dy, relative to the sheet PM. As shown in FIG. 3, the L nozzle groups NK, NY, NC, and NM are arranged in the moving direction DxM. That is, the nozzle groups are aligned along the moving direction DxM. Each of the nozzle groups NK, NY, NC, and NM includes multiple nozzles NZ, which are located at different positions in the conveying direction Dy. The nozzles NZ are configured to eject ink to form dots on the sheet PM.

The processor 210 of the controller 299 (FIG. 1) executes the following processes according to the program 232. By executing S130 and S160 (FIG. 5), the processor 210 generates job data. In S170, the processor 210 transmits the job data to the print engine 400. In this manner, the processor 210 causes the print engine 400 to print each of the plurality of band images BI1 to BIn, which together form the objective image OI (FIG. 4), through multiple pass processes P (FIGS. 8 to 11). The processor 210 thus functions as an example of a band processing unit that performs such processes (S130, S160, and S170). Here, the band images BI1 to BIn (FIG. 4) are aligned in the conveying direction Dy on the sheet PM. Each pass process P (FIGS. 8 to 11) involves forming multiple dots along a raster line RL extending in the moving direction DxM, by driving the print head 410 while the print head 410 is being moved. The band images BI1 to BIn (FIG. 4) each include multiple raster lines aligned in the conveying direction Dy at a line resolution Rrl that is N times (N is an integer equal to or greater than 2) the nozzle resolution Rnz (FIG. 3). The nozzle resolution Rnz (FIG. 3) indicates the density of the nozzles NZ in the conveying direction Dy.

The processor 210 is operable in the semi-high-quality mode MD3 (FIG. 10), which is a processing mode for causing the print engine 400 to print a band image through multiple pass processes P. As described above with reference to the pass processes P(k+1) to P(k+4) in FIG. 10, the semi-high-quality mode MD3 is a bidirectional printing mode in which the print engine 400 performs multiple pass processes P with alternate execution of forward pass processes Pf and reverse pass processes Pr. The forward pass process Pf is a pass process in which the print head 410 is moved in the forward direction F parallel to the moving direction DxM, and the reverse pass process Pr is a pass process in which the print head 410 is moved in the reverse direction R opposite to the forward direction F.

The multiple pass processes P in the semi-high-quality mode MD3 include a preceding pass process P(k+2) and a succeeding pass process P(k+3). The preceding pass process P(k+2) is a pass process that forms part of the multiple dots on a partial line group LG, which is a group of multiple raster lines RLs representing a portion of the band image BI(i). Hereinafter, such a pass process P(k+2) is also referred to as a preceding pass process Pa. In the example shown in FIG. 10, the preceding pass process P(k+2) is a forward pass process Pf. Although not illustrated, the movement order of an adjacent band image BI(i–1), which is printed prior to the band image BI(i), may be RFR instead of FRF. In such a case, the movement order of the band image BI(i) may be FRFR instead of RFRF. Thus, the preceding pass process P(k+2) may alternatively be a reverse pass process Pr.

The succeeding pass process P(k+3) is performed after the preceding pass process P(k+2), without moving the sheet PM in the conveying direction Dy. The succeeding pass process P(k+3) is a pass process that forms the remaining dots of the partial line group LG consisting of multiple raster lines RLs. Hereinafter, such a pass process P(k+3) is also referred to as a succeeding partial pass process Pb. In the succeeding pass process P(k+3), the print head 410 is moved in a direction opposite to the moving direction of the print head 410 in the preceding pass process P(k+2).

According to this configuration, dots are formed on the multiple raster lines RLs by both the preceding pass process P(k+2) and the succeeding pass process P(k+3), which is performed in the direction opposite to that of the preceding pass process P(k+2). Accordingly, the possibility that the perceived color of the printed raster lines RLs is biased toward the perceived color resulting from all dots being formed by the forward pass process Pf is reduced. Likewise, the possibility that the perceived color is biased toward the perceived color resulting from all dots being formed by the reverse pass process Pr is also reduced. As a result, it is possible to suppress the likelihood that the band image including the multiple raster lines RLs appears to differ in color from other band images that are supposed to exhibit the same color. For example, the perceived color difference between the printed band images BI(i−1) and BI(i) in FIG. 10 is smaller than the perceived color difference between the band images BI(i−1) and BI(i) in FIG. 8. Furthermore, the semi-high-quality mode MD3 is a bidirectional print processing mode. Compared to a case in which a skip process SK is performed in addition to the preceding pass process P(k+2) and the succeeding pass process P(k+3), this configuration allows faster printing.

The forward direction F is an example of a first direction parallel to the moving direction DxM. The forward pass process Pf is an example of a first-direction pass process, in which the print head 410 is moved in the first direction. The reverse direction R is an example of a second direction opposite to the first direction. The reverse pass process Pr is an example of a second-direction pass process, in which the print head 410 is moved in the second direction. The semi-high-quality mode MD3 is an example of a first mode that causes the print engine 400 to print a band image by multiple pass processes including the preceding partial pass process and the succeeding partial pass process. A band image to which the semi-high-quality mode MD3 is applied (e.g., the band image BI(i) shown in FIG. 10) is an example of a first specific band image to which the first mode is applied.

In the present embodiment, the total number of pass processes P in the semi-high-quality mode MD3 is four, which is an even number. In the multiple pass processes P in the semi-high-quality mode MD3, the number of forward pass processes Pf (i.e., 2) is equal to the number of reverse pass processes Pr (i.e., 2). Accordingly, the possibility that the perceived color varies between multiple band images to which the semi-high-quality mode MD3 is applied is reduced.

In the present embodiment, the processor 210 is operable in the semi-high-speed mode MD2 (FIG. 9). As shown in FIG. 9, the total number of pass processes P for printing the adjacent band image BI(i–1), which is printed prior to the band image BI(i) to which the semi-high-speed mode MD2 is applied, can be an odd number (three in the example of FIG. 9). In the semi-high-speed mode MD2, the print engine 400 is caused to perform the skip process SK, the forward pass process Pf, and the reverse pass process Pr. The skip process SK is a process of moving the print head 410 without forming dots. The number of forward pass processes Pf is equal to the number of forward pass processes Pf for printing the adjacent band image BI(i–1) (two in FIG. 9), and the number of reverse pass processes Pr is equal to the number of reverse pass processes Pr for printing the adjacent band image BI(i–1) (one in FIG. 9). According to this configuration, when the band image BI(i) and the adjacent band image BI(i–1) are intended to represent the same color, the likelihood that the printed band images BI(i) and BI(i–1) are perceived to have different colors is reduced.

The semi-high-speed mode MD2 is an example of a second mode in which the print engine 400 performs the above-described moving process including the skip process SK. The band image which is the adjacent band image to be printed subsequent to the band image by the odd number of pass processes, and to which the semi-high-speed mode MD2 is applied (e.g., the band image BI(i) shown in FIG. 9), is an example of a second specific band image to which the second mode is applied.

In the present embodiment, no other band image exists between one band image and its adjacent band image. The term "band image and the adjacent band image" refers to two band images that are consecutive in the conveying direction Dy. The phrase "band image and two adjacent band images" refers to three band images that are successive in the conveying direction Dy. The adjacent band image printed prior to the target band image (e.g., the second specific band image) indicates one of the two adjacent band images whose printing is completed before the printing of the target band image.

In the present embodiment, the processor 210 is operable in Q processing modes (Q is an integer of two or more; in the present embodiment, Q = 4) for causing the print engine 400 to print band images, including the first mode (here, the semi-high-quality mode MD3). In S130 of FIG. 5, the processor 210 executes the processing shown in FIG. 6. In S215, S217, S220, S230, and S240, the processor 210 analyzes the target band image to determine, in Q levels, the magnitude of perceived color differences in the target band image caused by the difference in the moving directions of the print head 410 during the pass processes P. As described with reference to FIGS. 7A to 7D, the degree of banding of the block BL calculated in S215 (i.e., small B-S, medium B-M, large B-L, and very large B-LL) indicates the magnitude of perceived color differences due to the directional variation in the pass processes P. The total numbers N-S, N-M, N-L, and N-LL of the respective blocks calculated in S217 serve as examples of parameters indicative of the magnitude of perceived color differences in the target band image. In S225, S235, S245, and S250, the processor 210 selects a processing mode associated with the determined level of perceived color difference in the target band image. In S265, the processor 210 determines the configuration of interlace printing, including the arrangements of multiple moving processes and multiple conveying processes, based on the selected processing mode. In S160 and S170 of FIG. 5, the processor 210 causes the print engine 400 to print the target band image in accordance with the determined interlace printing configuration (i.e., the selected processing mode). With this configuration, the processor 210 can cause the print engine 400 to print the target band image in a processing mode corresponding to the determined level of perceived color difference.

In the present embodiment, the total number Q of the processing modes is three or more. Therefore, compared to a case in which the total number Q is less than three, the processor 210 can cause the print engine 400 to print the target band image in a processing mode that is more appropriately suited to the magnitude of the perceived color difference in the target band image.

In the present embodiment, the processor 210 has multiple processing modes for causing the print engine 400 to print a band image, including a first mode (i.e., the semi-high-quality mode MD3). The multiple processing modes include the above-described modes MD1, MD2, and MD3 (FIGS. 8, 9, and 10).

In the high-speed mode MD1 (FIG. 8), three pass processes P in the order of RFR or three pass processes P in the order of FRF can be executed. In the semi-high-speed mode MD2 (FIG. 9), three pass processes P in the order of RFF included in four moving processes with the order of RF(R)F, or three pass processes P in the order of FFR included in four moving processes with the order of F(R)FR can be executed. In the semi-high-quality mode MD3 (FIG. 10), four pass processes P in the order of RFRF can be executed. Although not illustrated, four pass processes P in the order of FRFR can also be executed.

As described above, the multiple modes MD1, MD2, and MD3 cause the print engine 400 to perform both printing of the band image through multiple pass processes starting from a forward pass process Pf and printing through multiple pass processes starting from a reverse pass process Pr. If the multiple pass processes P for printing a band image always begin with pass processes in the same direction, the number of skip processes SK may increase in order to adjust the moving direction of the print head 410. As a result, the printing speed may decrease. When one of the modes MD1, MD2, or MD3 is applied to each of multiple consecutive band images, the skip processes SK for adjusting the moving direction of the print head 410 can be omitted, thereby reducing the possibility of a decrease in printing speed.

In the present embodiment, the semi-high-quality mode MD3 (FIG. 10), which is an example of the first mode, enables the print engine 400 to perform printing of a band image through multiple pass processes P (RFRF) starting from a reverse pass process Pr. These multiple pass processes P include a preceding partial pass process Pa and a succeeding partial pass process Pb, which are performed consecutively without conveying the sheet PM. Although not illustrated, the semi-high-quality mode MD3 may also enable printing of a band image through multiple pass processes P (FRFR) starting from a forward pass process Pf. In this case, the second and third pass processes among the four correspond respectively to the preceding partial pass process Pa and the succeeding partial pass process Pb, both executed without conveying the sheet PM. Thus, the semi-high-quality mode MD3 allows the print engine 400 to perform both types of band image printing: one starting with a forward pass process Pf and the other starting with a reverse pass process Pr. When the semi-high-quality mode MD3 is applied to multiple consecutive band images, skip processes SK for adjusting the movement direction of the head 410 can be omitted, thereby reducing the likelihood of decreased print speed.

FIG. 12 is a flowchart illustrating image processing according to a second embodiment. The image processing shown in FIG. 12 differs from that shown in FIG. 5 only in that the processing mode is selected on a per-page basis in the present embodiment. The available processing modes are the same as those in the first embodiment—namely, the four modes MD1 to MD4 (FIGS. 8 - 11). In the present embodiment, the program 232 is configured to execute the process shown in FIG. 12. The processor 210 performs the process of FIG. 12 in accordance with the program 232.

S110 and S120 in FIG. 12 are the same as S110 and S120 in FIG. 5, respectively. The processor 210 obtains the target image data and performs a color conversion process on the target image data.

In S130b, the processor 210 performs a color banding mode process. Unlike S130 in FIG. 5, the processor 210 selects the processing mode for each page.

FIG. 13 is a flowchart illustrating an example of the color banding mode process. Unlike the process shown in FIG. 6, the processing mode is selected for each page instead of for each band image.

In S210b, the processor 210 selects, as the target page image, an image of an unprocessed page among images of U pages (U being an integer equal to or greater than one) represented by the target image data. Then, the processor 210 obtains the data of the target page image from the target image data and the color-converted target image data.

In S215b, the processor 210 calculates the degree of banding for each block in the target page image. The calculation process of the degree of banding of the block BL is the same as that described with reference to FIGS. 7A to 7C.

In S217b (FIG. 13), the processor 210 calculates the total number of blocks within the target page image. In the present embodiment, the processor 210 respectively calculates the total numbers Np-S, Np-M, Np-L, and Np-LL of the small blocks B-S, the medium blocks B-M, the large blocks B-L, and the very large blocks B-LL. The greater the degree of banding of the blocks BL included in the target page image, the more likely the image is to exhibit visible banding. In the present embodiment, the processing mode for interlace printing of the target page image is selected from the four modes MD1 to MD4 so as to reduce the possibility of noticeable banding.

S220b to S250b are the same as S220 to S250 in FIG. 6, except that the total numbers N-S, N-M, N-L, and N-LL of the various blocks in the target band image are replaced with the total numbers Np-S, Np-M, Np-L, and Np-LL of the various blocks in the target page image.

If the number Np-LL of very large blocks is one or more (S220b: YES), the high-quality mode MD4 is selected (S225b). If the number Np-LL of very large blocks is less than one and the number Np-L of large blocks is one or more (S220b: NO, S230b: YES), the semi-high-quality mode MD3 is selected (S235b). If the number Np-L of large blocks is less than one and the number Np-M of medium blocks is one or more (S230b: NO, S240b: YES), the semi-high-speed mode MD2 is selected (S245b). If the number Np-M of medium blocks is less than one (S240b: NO), the high-speed mode MD1 is selected (S250b).

In S260b, the processor 210 generates image data for printing by performing a halftone process using the color-converted data of the target page image. The method of the halftone process is the same as the method of the halftone process in S260 of FIG. 6.

In S265b, the processor 210 determines the configuration of the interlace printing for the target page image in accordance with the print image data of the target page image and the processing mode selected in S220b to S250b. In the present embodiment, multiple band images included in the target page image are processed using the same processing mode.

In S270b, the processor 210 determines whether all the pages have been processed. If there are any pages that have not been processed (S270b: NO), the processor 210 proceeds to S210b to process the next page. If all the pages have been processed (S270b: YES), the processor 210 terminates the process shown in FIG. 13, that is, the process of S130b in FIG. 12.

S160 and S170 in FIG. 12 are the same as those in FIG. 5, respectively. The processor 210 generates the job data and transmits the generated job data to the print engine 400. The control circuit 490 of the print engine 400 prints U pages of images on U sheets PM, respectively, based on the job data. Then, the process in FIG. 12 is terminated.

As described above, in the present embodiment, the processor 210 is configured to select the processing mode on a page-by-page basis. Accordingly, the processor 210 can cause the print engine 400 to print each page image in the processing mode suitable for the respective page.

It should be noted that, in the present embodiment, the image processing for printing is performed in the same manner as in the first embodiment, except that the processing mode is selected on a page-by-page basis. Therefore, the present embodiment can provide the same various advantages as those provided by the first embodiment.

FIG. 14 is a flowchart illustrating the image processing according to the third embodiment. The main difference from the image processing shown in FIGS. 5 and 12 is that, in the third embodiment, the processing mode is selected based on a user instruction. The available processing modes are the same four modes MD1 to MD4 (FIGS. 8 to 11) as in the first embodiment. In the present embodiment, the program 232 is configured to execute the process shown in FIG. 14. Accordingly, the processor 210 performs the process shown in FIG. 14 in accordance with the program 232.

S110 and S120 in FIG. 14 are the same as those in FIG. 5, respectively. The processor 210 obtains the target image data and performs the color conversion process on the target image data.

In S132c, the processor 210 displays a setting screen on the display 240 to receive the user instruction to select the processing mode. FIG. 15 shows an example of the setting screen UI. The setting screen UI shows a slider SL and a complete button BT. The user operates the operation panel 250 to move the slider SL to select one of the four levels from "High Speed" to "High Quality." The four levels correspond to the four modes MD1 to MD4 (FIGS. 8 to 11), respectively. The user can then complete the level selection by operating the complete button BT through the operation panel 250.

In S134c (FIG. 14), the processor 210 obtains the user instruction to select the level in response to the operation of the complete button BT. In S136c, the processor 210 determines the processing mode in accordance with the user instruction. In the present embodiment, the processing mode is applied commonly to all the pages of the target image data. Alternatively, the processor 210 may allow the user to select the processing mode on a page-by-page basis.

In S140c, the processor 210 generates the image data for printing by performing a halftone process using the data of the color-converted target image. The halftone method is the same as that in S260 of FIG. 6.

In S150c, the processor 210 determines the configuration of the interlace printing for each page of the target image data in accordance with the print image data and the processing mode determined in S136c.

S160 and S170 in FIG. 14 are the same as those in FIG. 5, respectively. The processor 210 generates the job data and transmits the generated job data to the print engine 400. The control circuit 490 of the print engine 400 prints each page image in accordance with the job data. Then, the process of FIG. 14 is terminated.

As described above, in the present embodiment, the processor 210 is configured to operate in any of V processing modes (V being an integer equal to or greater than three) including the first mode (i.e., the semi-high-quality mode MD3) as the processing mode for causing the print engine 400 to print the band images. The processor 210 performs the following processes in accordance with the program 232. In S132c, the processor 210 displays a setting screen UI (FIG. 15) on the display 240. The setting screen UI is an example of a screen for receiving user instructions to select a processing mode for causing the print engine 400 to print multiple band images. In S136c, the processor 210 determines the processing mode for causing the print engine 400 to print the multiple band images in accordance with the user instructions. According to this configuration, the processor 210 can cause the print engine 400 to print the band images in a processing mode suitable to the user instruction.

In the present embodiment, the image processing for printing is performed in the same way as the image processing of the second embodiment, except that the processing mode is determined based on the user instruction. Therefore, the present embodiment can provide the same various advantages as those provided by the second embodiment.

Modifications

While aspects of the present disclosure have been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the present disclosure, as set forth above, are intended to be illustrative, and not limiting. Various changes may be made without departing from the spirit and scope of the present disclosure. Therefore, the present disclosure is intended to embrace all known or later developed alternatives, modifications, variations, improvements, and/or substantial equivalents. Some specific examples of potential alternatives, modifications, or variations in the described aspects of the present disclosure are provided below.

(1) The process of determining the degree of perceived color difference of the target band image is not limited to the process illustrated in FIG. 6, and various processes may be employed. For example, the thresholds used in S220, S230, and S240 may have values greater than one.

(2) The configuration of the interlace printing in the case where the semi-high-quality mode MD3 (FIG. 10) is applied may be various configurations in which the forward pass process Pf and the reverse pass process Pr are alternately executed and which include the preceding partial pass process Pa and the succeeding partial pass process Pb. For example, the processor 210 may determine the configuration of the interlace printing by dividing one of the N pass processes P, which would be performed if the high-speed mode MD1 were assumed to be applied, into the preceding partial pass process Pa and the succeeding partial pass process Pb. In this case, it is preferable that the pass process P associated with the smaller number of the forward pass processes Pf and the reverse pass processes Pr be divided. According to such a configuration, the direction of the pass processes P after the divided pass process P is reversed, so that the difference between the total number of dots formed by the forward pass processes Pf and the total number of dots formed by the reverse pass processes Pr is reduced. Consequently, it is possible to reduce the perceived color difference between the band image printed in the semi-high-quality mode MD3 and various other band images supposed to exhibit the same color. Further, in the semi-high-quality mode MD3, the print engine 400 may be caused to perform only one of printing the band image by multiple pass processes P starting from the forward pass process Pf or printing the band image by multiple pass processes P starting from the reverse pass process Pr. In either case, the first specific band image to which the semi-high-quality mode MD3 is applied may be any of various band images, and is not limited to the band images to which the semi-high-quality mode MD3 is applied in the embodiments shown in FIGS. 6, 13, and 14.

(3) The configuration of the interlace printing in the case where the semi-high-speed mode MD2 (FIG. 9) is applied may include various configurations comprising the skip process SK, the forward pass processes Pf in the same number as the number of the forward pass processes Pf performed for the adjacent band image printed earlier, and the reverse pass processes Pr in the same number as the number of the reverse pass processes Pr performed for the adjacent band image printed earlier. Among the multiple moving processes including the skip process SK and the pass processes P, the order of execution of the skip process SK may be arbitrary. It is preferable that the number of the skip process SK is one. In any case, the band image to which the semi-high-speed mode MD2 is applied may be various band images, not limited to the band images to which the semi-high-speed mode MD2 is applied in the embodiments shown in FIGS. 6, 13, and 14. It is noted that the band image (e.g., the band image BI(i) shown in FIG. 9), which is the band image printed subsequent to the band image printed by an odd number of pass processes P and to which the semi-high-speed mode MD2 is applied, is an example of a second specific band image to which the second mode is applied.

(4) It is noted that, in the high-quality mode MD4 (FIG. 11), the dots may be formed by the reverse pass processes Pr instead of the forward pass processes Pf.

(5) The usable processing modes are not limited to the modes MD1 to MD4 (FIGS. 8-11), but may include various modes. For example, one or more modes arbitrarily selected from the modes MD1 to MD4 may be omitted. For instance, the usable modes may include the high-speed mode MD1 and the semi-high-quality mode MD3. The usable modes may further include the semi-high-speed mode MD2. It is preferable that the usable modes include the semi-high-quality mode MD3, more preferable to include the semi-high-speed mode MD2, especially preferable to include the high-speed mode MD1, and most preferable to include the high-quality mode MD4.

In any case, the usable mode may be configured to cause the print engine 400 to perform either printing the band image by the multiple pass processes P starting from the forward pass process Pf or printing the band image by the multiple pass processes P starting from the reverse pass process Pr.

(6) If the magnitude of the perceived color difference of the target band image due to the difference in moving directions of the print head is determined as in the embodiment shown in FIG. 6, the number Q of steps indicating the magnitude may be any number of two or more. The number of steps Q may be the same as the total number of the usable modes.

(7) The resolution multiplier N of the resolution Rrl (FIG. 4) of the raster lines RL in the conveying direction Dy to the resolution Rnz (FIG. 3) of the nozzles NZ in the conveying direction Dy is not limited to three, but may be any integer of two or more. In any case, one band image can be printed by N times or more pass processes P.

The resolution multiplier N may be any odd number. When bidirectional printing is performed, as shown in the example of FIG. 8, the total number of raster lines RL associated with the forward direction F may differ between two consecutive band images, and the total number of raster lines RL associated with the reverse direction R may also differ between two consecutive band images. As a result, banding may become noticeable. The usable processing modes may include the high-speed mode MD1 and the semi-high-quality mode MD3. When a band image printed in the high-speed mode MD1 is adjacent to a band image printed in the semi-high-quality mode MD3, the possibility that banding is noticeable between those band images is reduced. It should also be noted that the resolution multiplier N may be any even number.

(8) The total number Nnz of the nozzles NZ in each of the nozzle groups NK, NY, NC, and NM (FIG. 3) may be any integer equal to or greater than two. Further, the total number Nrl of the raster lines RL (FIG. 4) included in one band image may also be any integer equal to or greater than two. The total number Nrl of the raster lines RL may be the same as the total number Nnz of the nozzles NZ, or may be different from the total number Nnz.

(9) The number L of ink types usable by the print engine 400 is not limited to four, but may be any integer equal to or greater than two. For example, the black ink K may be omitted. In addition to the cyan ink C, a light cyan ink may also be usable. Two types of color inks (e.g., cyan C and magenta M) may be usable. Two types of achromatic inks (e.g., black K and gray) may be usable.

(10) For the determination of the flag FL in FIG. 7C, various types of evaluation values indicating color differences may be used instead of the difference of L* values in the CIELAB color space. For example, a color difference value (e.g., based on the CIE DE2000 color difference formula) in the CIELAB color space may be used.

(11) In the embodiment shown in FIG. 4, two adjacent band images are arranged in the conveying direction Dy without overlapping each other and without any gap therebetween. Instead of this configuration, two adjacent band images may be arranged such that they partially overlap each other. The raster lines RL in the overlapped portion may be distributed to the two band images.

(12) The total number Nd of types of dots that can be formed by the print engine 400 may be any integer equal to or greater than one. For example, the total number Nd of dot types may be one. That is, an image may be represented by the presence or absence of dots. Instead of such a configuration, two or more types of dots having different sizes may be formed. In either case, the halftone process may be configured to determine the formation states of the Nd types of dots.

(13) The configuration of the print engine 400 is not limited to the configuration described with reference to FIGS. 2 and 3, but can be any configuration. For example, the head driving unit 420 may be incorporated into the print head 410. The ink supplying unit 450 (including the cartridge mounting section 451) may be mounted on the carriage 443. The MFP 200 may be provided with large-capacity ink tanks instead of the ink cartridges KC, YC, CC, and MC and the cartridge mounting section 451. The print engine 400 may be configured with any combination of the print head, the conveying mechanism, and the moving mechanism. The print head may have various configurations that include L nozzle groups for ejecting L types of ink (L being an integer equal to or greater than two). The conveying mechanism may be configured in any manner that conveys the sheet PM in the conveying direction relative to the print head. The moving mechanism may be configured in any manner that moves the print head relative to the sheet PM in a moving direction that intersects the conveying direction.

(14) The medium used for printing is not limited to the sheet PM, but may be various types of sheets, including film sheets, fabric sheets, and other similar media.

(15) The controller configured to control the print engine 400 is not limited to the controller 299 shown in FIG. 1, but may be various types of devices. For example, the controller may be an external data processing device (e.g., a personal computer, a tablet computer, or a smartphone) connected to the print engine. Alternatively, multiple devices (e.g., computers) communicable with each other via a network may share parts of the image processing function performed by the controller, and thus provide the image processing function as a whole. In such a case, a system including such devices corresponds to the controller according to aspects of the present disclosure.

In each of the above-described embodiments, part of the configuration implemented by hardware may be replaced with software, or conversely, part or all of the configuration implemented by software may be replaced with hardware. For example, the processes shown in FIGS. 6 or 13 may be executed by a dedicated hardware circuit such as an Application Specific Integrated Circuit (ASIC).

Alternatively, part or all of the functions according to aspects of the present disclosure may be implemented by computer program(s). Such computer program(s) may be supplied in the form of a computer-readable recording medium (e.g., a non-transitory recording medium) containing computer-executable instructions representing the program(s). The computer program(s) may be used while stored in a recording medium (i.e., a computer-readable recording medium) that is the same as or different from the one used when the program(s) were initially supplied. The term "computer-readable recording medium" is not limited to portable recording media such as a memory card or CD-ROM, but may include internal storage devices (e.g., various types of ROM) in a computer, and/or external storage devices such as hard disk drives connected to the computer.

It should be noted that the above-described embodiments and modifications can be implemented either individually or in any combination. Such combinations may provide further advantages and flexibility in implementation. These combinations are also intended to be within the scope of aspects of the present disclosure.

In general, the present disclosure provides a technique that allows a printer to perform bidirectional printing in which the print head reciprocates along a moving direction intersecting the sheet conveying direction. In this configuration, a preceding printing process is executed by moving the print head in a first direction to form part of a band image, and a succeeding printing process is executed by moving the print head in a second direction opposite to the first direction to complete the printing of the band image. By controlling the allocation of the preceding printing and the succeeding printing, aspects of the present disclosure can effectively suppress banding phenomena that may otherwise occur in bidirectional printing.

According to the embodiments and modifications described above, the print head includes multiple nozzle groups arranged in the moving direction, each group having a plurality of nozzles aligned at different positions in the conveying direction. The band image to be printed includes multiple raster lines arranged at a resolution that is an integer multiple of the nozzle resolution in the conveying direction, thereby enabling high-quality printing even at high resolutions. Aspects of the present disclosure can thus achieve high-speed and high-quality printing by efficiently performing the preceding and succeeding printings while suppressing banding phenomena.

What is claimed is:

1. A controller configured to control a print engine of a printer, the print engine having:
a print head including L nozzle groups configured to eject L types of ink, where L is an integer greater than or equal to two;
a conveying mechanism configured to convey a sheet in a conveying direction relative to the print head; and
a moving mechanism configured to move the print head in a moving direction intersecting the conveying direction relative to the sheet,
wherein the L nozzle groups are arranged in the moving direction and include a plurality of nozzles disposed at different positions in the conveying direction, each nozzle being configured to eject ink to form dots on the sheet,
wherein the controller is configured to:
cause the print engine to perform a band processing to print multiple band images that together form a target image, the multiple band images being arranged in the conveying direction on the sheet;
wherein each of the multiple pass processes includes forming multiple dots on raster lines extending in the moving direction by driving the print head while moving the print head;
wherein each band image includes multiple raster lines arranged in the conveying direction at a resolution that is N times a nozzle resolution in the conveying direction of the multiple nozzles, where N is an integer greater than or equal to two,
wherein the band processing is configured to operate in a first mode that causes the print engine to print a first specific band image included in the multiple band images using multiple pass processes,
wherein the first mode is a bidirectional printing mode configured to cause the print engine to perform the multiple pass processes by alternately executing a first-direction pass process that moves the print head in a first direction parallel to the moving direction and a second-direction pass process that moves the print head in a second direction opposite to the first direction,
wherein the multiple pass processes in the first mode include:
a preceding pass process that is either the first-direction pass process or the second-direction pass process, and that forms a portion of multiple dots of a partial line group representing part of the first specific band image; and
a succeeding pass process performed, without conveying the sheet in the conveying direction, after the preceding pass process to form the remaining multiple dots of the partial line group, the print head being moved in a direction opposite to the direction in which the print head is moved in the preceding pass process.

2. The controller according to claim 1,
wherein a total number of the multiple pass processes in the first mode is an even number, and
wherein, among the multiple pass processes in the first mode, a number of the first-direction pass processes is equal to a number of the second-direction pass processes.

3. The controller according to claim 1,
wherein the controller is configured to cause the print engine to perform a second mode that causes the print engine to print a second specific band image included in the multiple band images,
wherein a total number of multiple pass processes for printing an adjacent band image that is printed prior to the second specific band image is an odd number, and
wherein in the second mode, the controller is configured to cause the print engine to perform:
a process of moving the print head without forming dots;
a number of the first direction pass processes equal to a number of the first direction pass processes for printing the adjacent band image; and
a number of the second direction pass processes equal to a number of the second direction pass processes for printing the adjacent band image.

4. The controller according to claim 1,
wherein the controller is configured to cause the print engine to perform band processing in any one of Q processing modes, where Q is an integer equal to or greater than two, and
wherein the controller is further configured to:
determine, in Q stages respectively corresponding to the Q processing modes, a magnitude of a difference in perceived color of the target band image caused by a directional variation in the pass process; and
cause the print engine to print the target band image using the processing mode corresponding to the stage of the magnitude of the difference in the perceived color.

5. The controller according to claim 4,
wherein a total number Q of the processing modes is three or more.

6. The controller according to claim 1,
wherein the controller is configured to cause the print engine to perform printing of a band image included in the multiple band images by using a processing mode including the first mode, and
wherein the multiple processing modes include a mode to cause the print engine to perform printing of the band image by multiple pass processes starting from the first direction pass process and a mode to cause the print engine to perform printing of the band image by multiple pass processes starting from the second direction pass process.

7. The controller according to claim 1,
wherein the first mode is configured to cause the print engine to perform printing of the band image by multiple pass processes including the preceding pass process and the succeeding pass process starting from the first direction pass process, and printing of the band image by multiple pass processes including the preceding pass process and the succeeding pass process starting from the second direction pass process.

8. The controller according to claim 1,
wherein the controller is configured to have V processing modes including the first mode, as the processing modes to cause the print engine to perform printing of the band images included in the multiple band images, where V being an integer equal to or greater than three, and
wherein the controller is further configured to:
cause a display device to display a screen for receiving a user instruction to select the processing mode for causing the print engine to perform printing of the multiple band images; and
determine the processing mode for causing the print engine to perform printing of the multiple band images in accordance with the user instruction.

9. A method of controlling a print engine of a printer, the print engine comprising a print head having L nozzle groups configured to eject L types of ink, where L is an integer equal to or greater than two, a conveying mechanism configured to convey a sheet in a conveying direction relative to the print head, and a moving mechanism configured to move the print head in a moving direction relative to the sheet, the L nozzle groups being arranged in the moving direction, the L nozzle groups including multiple nozzles of which positions in the conveying direction are different from each other, the multiple nozzles being configured to eject ink to form dots on the sheet,
the method comprising:
causing the print engine to print multiple band images forming a target image to be processed, the multiple band images being arranged in the conveying direction on the sheet, by performing multiple pass processes, each of the multiple pass processes including a process of forming multiple dots on raster lines extending in the moving direction by driving the print head while the print head is being moved, the multiple band images including multiple raster lines arranged in the conveying direction at a resolution N times a resolution of the multiple nozzles in the conveying direction, where N is an integer equal to or greater than two;
wherein the multiple pass processes include a first mode for causing the print engine to print a first specific band image included in the multiple band images;
wherein the first mode is a bidirectional print mode that causes the print engine to perform the multiple pass processes representing alternate execution of a first direction pass process to move the print head in a first direction parallel to the moving direction and a second direction pass process to move the print head in a second direction opposite to the first direction;
wherein the multiple pass processes in the first mode include:
a preceding pass process, which is either the first direction pass process or the second direction pass process, to form part of multiple dots of a partial line group that is a group of multiple raster lines representing part of the first specific band image; and
a succeeding pass process, performed without moving the sheet in the conveying direction after the preceding pass process, to form the remainder of the multiple dots of the partial line group, the succeeding pass process moving the print head in a direction opposite to the direction in which the print head is moved in the preceding pass process.

10. A non-transitory computer-readable storage medium for a print engine of a printer, the print engine having a print head with L nozzle groups configured to eject L types of ink, where L is an integer equal to or greater than two, a conveying mechanism configured to convey a sheet in a conveying direction relative to the print head, and a moving mechanism configured to move the print head in a moving direction relative to the sheet, the L nozzle groups being arranged in the moving direction, the L nozzle groups including multiple nozzles of which positions in the conveying direction are different from each other, the multiple nozzles being configured to eject ink to form dots on the sheet, the storage medium containing computer-executable instructions that cause, when executed by a computer, the print engine to perform:
printing multiple band images forming a target image to be processed, the multiple band images being aligned in the conveying direction on the sheet by multiple pass processes, each of the pass processes including forming multiple dots on raster lines extending in the moving direction by driving the print head while the print head is being moved, the multiple band images including multiple raster lines arranged in the conveying direction at a resolution that is N times a resolution of the multiple nozzles in the conveying direction, where N is an integer equal to or greater than two; and
printing, in a first mode, a first specific band image included in the multiple band images by multiple pass processes, the first mode being a bidirectional print mode that includes alternate execution of a first direction pass process for moving the print head in a first direction parallel to the moving direction and a second direction pass process for moving the print head in a second direction opposite to the first direction,
wherein the multiple pass processes in the first mode include:
a preceding pass process which is either the first direction pass process or the second direction pass process to form part of multiple dots of a partial line group that is a group of multiple raster lines representing part of the first specific band image; and
a succeeding pass process performed, without moving the sheet in the conveying direction, after the preceding pass process to form the remainder of the multiple dots of the partial line group, wherein the print head is moved in a direction opposite to the direction in which the print head is moved in the preceding pass process.

11. A printer comprising:
means for conveying a sheet in a conveying direction;
means for moving a print head in a moving direction intersecting the conveying direction; and
means for performing a bidirectional printing to print a band image, the bidirectional printing including:
a preceding printing by moving the print head in a first direction along the moving direction to print part of the band image; and
a succeeding printing by moving the print head in a second direction opposite to the first direction to print the remainder of the band image,
wherein the means for performing the bidirectional printing is configured to optimize an allocation of the preceding printing and the succeeding printing in order to suppress banding phenomenon.
